(19) United States
(12) Patent Application Publication
(10) Pub. No.: US 2023/0144260 A1
(43) Pub. Date: May 11, 2023

(54) LIQUID SUPPLY METHOD

(71) Applicant: Hitachi, Ltd., Tokyo (JP)

(72) Inventors: Itaru YANAGI, Tokyo (JP); Takeshi ISHIDA, Tokyo (JP)

(21) Appl. No.: 17/971,670

(22) Filed: Oct. 24, 2022

(30) Foreign Application Priority Data
Nov. 5, 2021 (JP) 2021-180901

(51) Int. Cl. B01L 3/00; C08L 75/04; C08L 7/00; C08L 27/12; C08L 43/04; C08L 23/02; C08L 91/08

(52) U.S. Cl. CPC B01L 3/561; C08L 75/04; C08L 7/00; C08L 27/12; C08L 43/04; C08L 23/025; C08L 91/08

(57) ABSTRACT

The method includes preparing a liquid supply pipe in which the solution to be inspected, air, and oil are disposed in this order, and installing the liquid supply pipe above the substrate at an angle such that the solution to be inspected is positioned on a lowermost side and the solution to be inspected, the air, and the oil flow onto a front surface of the substrate by gravity. A cross-sectional area of the liquid supply pipe is designed such that the air continues to be present between the solution to be inspected and the oil while the solution to be inspected, the air, and the oil are flowing through the liquid supply pipe, and after the solution to be inspected is supplied to the spot, the solution to be inspected present on the front surface of the substrate is replaced with the air, and then the liquid supply progresses.

### CROSS REFERENCE TO RELATED APPLICATIONS

The present application claims priority from Japanese patent application JP 2021-180901 filed on Nov. 5, 2021, the entire content of which is hereby incorporated by reference into this application.

### BACKGROUND OF THE INVENTION

### 1. Field of the Invention

The present disclosure relates to a liquid supply method.

### 2. Description of the Related Art

As a more accurate inspection method than a polymerase chain reaction (PCR), a method called dPCR (digital PCR) has attracted attention. The dPCR is a method for discriminating whether or not there is a DNA sequence to be detected for each microdroplet by fractionating a solution to be inspected into microdroplets, performing a PCR reaction, and then performing fluorescence observation of each microdroplet. Since a volume of the fractionated droplet is minute, even when there is one copy of the DNA sequence to be detected in the droplet, after DNA to be detected is amplified through the PCR reaction, the DNA sequence to be detected has a concentration that can be sufficiently observed in the droplet. Thus, even in a case where the solution to be inspected contains only an extremely small amount of DNA sequences to be detected, it is possible to discriminate whether or not there is the DNA sequence to be detected in the solution to be inspected. Usually, the volume of the fractionated microdroplet is sufficiently small, and only about one copy or zero copy of the DNA sequence to be inspected is contained in each microdroplet. Accordingly, it is possible to count the number of DNA sequences to be detected originally present in the solution to be inspected by observing each droplet after the PCR reaction and counting the number of droplets in which the DNA sequence to be detected is amplified.

JP 2015-512508 A discloses a method for fractionating a solution to be inspected in dPCR. That is, the solution to be inspected is fractionated and filled in each through-hole by supplying the solution to be inspected to a sample loader and sliding the sample loader on a front surface of a chip on which an array of through-holes is disposed. Thereafter, an upper surface and a lower surface of the chip are filled with oil, and thus, the solutions filled in the through-holes are prevented from evaporating or the solutions in the adjacent holes are prevented from coming into contact with each other. Subsequently, the PCR reaction is performed.

The PCR reaction is performed, for example, by installing an array chip (a substrate having arrayed spots) on a thermal cycler and setting a temperature of the thermal cycler such that two temperatures of, for example, 60° C. and 98° C. are repeated. An enzyme and a primer necessary for amplifying the DNA sequence to be detected by the PCR reaction, and a probe that is specifically bound to the DNA sequence to be detected are introduced into the solution to be inspected in advance, and a fluorescent substance is bound to the probe. After the PCR reaction, the DNA sequence to be detected is amplified, and the probe with the fluorescent substance is bound thereto. This fluorescent substance is engineered to be capable of emitting fluorescence only when the probe is bound to the DNA sequence (see, for example, Tatsuo Nakagawa, et al., Anal. Chem. 2020, 92, 17, 11705-11713). Accordingly, when fluorescence observation is performed by irradiating the array of through-holes with excitation light after the PCR reaction, fluorescence derived from the DNA sequence to be detected is observed in a case where there is the DNA sequence in the through-holes, and fluorescence is not observed otherwise. That is, it is possible to know whether or not there is the DNA sequence to be detected based on whether or not there is the through-hole that emits fluorescence. It is possible to know the number of copies of the DNA sequence to be detected originally present in the solution to be inspected by counting the number of through-holes that emits fluorescence.

Xu Gao, et al., Biomicrofluidics 14, 034109 (2020); https://doi.org/10.1063/5.0006374 describes another method for fractionating the solution to be inspected by using the array of through-holes. That is, the chip in which the array of through-holes is disposed is incorporated in a flow path. The solution to be inspected is supplied to the flow path by using a syringe pump, and subsequently air is supplied. Thus, the solution to be inspected is fractionated and filled into the through-holes. Thereafter, an upper surface and a lower surface of the chip are filled with oil, and thus, the solutions filled in the through-holes are prevented from evaporating or the solutions in the adjacent holes are prevented from coming into contact with each other. Subsequently, the PCR reaction is performed. The method of the PCR reaction and the method of the subsequent fluorescence observation may be the same as described above.

### SUMMARY OF THE INVENTION

In JP 2015-512508 A, the solution to be inspected is fractionated and filled in the array of through-holes by sliding the sample loader on the front surface of the through-hole array chip. When the sample loader is slid onto the front surface of the through-hole array chip, an upper side of the chip is widely opened to the atmosphere. Thus, there is a high risk that foreign matters (particles), DNA, and the like floating in the atmosphere are mixed into the through-hole array. Due to a variation in an angle at which the loader comes into contact with the front surface of the array chip, a filling rate of the solution to be inspected into each through-hole changes, or partially there are through-holes that are not filled. Due to a variation in a position where the loader comes into contact with the chip front surface, partially there are through-holes that are not filled, or the solution to be inspected remains in a portion of a chip end other than the through-hole portion. Such a phenomenon leads to a decrease in inspection accuracy of the dPCR.

In JP 2015-512508 A, the solution filling into the through-hole using the loader is electrically performed by manufacturing a dedicated device. However, it takes a long time to complete the filling of the through-hole with the solution after mounting the chip on the device, and the through-hole cannot be filled with the solution unless electric power is used.

In Xu Gao, et al., Biomicrofluidics 14, 034109 (2020); https://doi.org/10.1063/5.0006374, the chip in which the array of through-holes is disposed is incorporated in the flow path. The solution to be inspected is supplied to the flow path by using the syringe pump, and subsequently the air is supplied. Thus, the solution to be inspected is fractionated and filled in the through-holes. In this method, since the array chip of the through-holes is incorporated in the flow path while the solution is being supplied, while each through-hole is being filled with the solution, and after each through-hole is filled with the solution, the upper side of the array chip is not widely opened to the atmosphere. Accordingly, as compared with the method in JP 2015-512508 A, there is a low risk that the foreign matters (particles), the DNA, and the like floating in the atmosphere are mixed into the through-hole array. The loader is not used unlike JP 2015-512508 A. Accordingly, as compared with the method in JP 2015-512508 A, the filling rate of the solution to be inspected into the through-hole becomes more uniform, and the solution to be inspected does not remain in the portion of the chip end other than the through-hole portion. However, the syringe pump is used for supplying the solution to the chip and supplying the air, and electric power is required for driving the syringe pump. Accordingly, even in this method, the solution cannot be filled into the through-hole without using electric power.

Therefore, the present disclosure provides a technology for filling a spot formed on a substrate with a solution to be inspected with good yield without using a loader, a syringe pump, and electric power.

In order to solve the above problems, the present disclosure provides a liquid supply method for supplying a solution to be inspected to a spot formed in a substrate. The method includes preparing a liquid supply pipe in which the solution to be inspected, air, and oil are disposed in this order, and installing the liquid supply pipe above the substrate at an angle such that the solution to be inspected is positioned on a lowermost side and the solution to be inspected, the air, and the oil flow onto a front surface of the substrate by gravity. A cross-sectional area of the liquid supply pipe is designed such that the air continues to be present between the solution to be inspected and the oil while the solution to be inspected, the air, and the oil are flowing through the liquid supply pipe, and after the solution to be inspected is supplied to the spot, the solution to be inspected present on the front surface of the substrate is replaced with the air, and then the liquid supply progresses such that the oil covers the front surface of the substrate.

Further features related to the present disclosure will become apparent from the description of the present specification and the accompanying drawings. The aspects of the present disclosure are achieved and realized by elements, combinations of various elements, the following detailed description, and aspects of the appended claims. The description of the present specification is merely a typical example, and does not limit the scope of claims or application examples of the present disclosure in any sense.

According to the technology of the present disclosure, it is possible to fill the spot formed on the substrate with the solution to be inspected with good yield without using the loader, the syringe pump, and the electric power. Other objects, configurations, and effects will be made apparent in the following descriptions.

### BRIEF DESCRIPTION OF THE DRAWINGS

FIG. 1A is a top view of an array chip according to a first embodiment;

FIG. 1B is a cross-sectional view taken along line A-A′ of FIG. 1A;

FIG. 1C is a top view of a state where the array chip is incorporated in a flow cell;

FIG. 1D is a cross-sectional view taken along line B-B′ of FIG. 1C;

FIG. 1E is a cross-sectional view taken along line C-C′ of FIG. 1C;

FIG. 2A is a top view illustrating a first modified example of a structure of the flow cell;

FIG. 2B is a top view illustrating a second modified example of the structure of the flow cell;

FIG. 2C is a top view illustrating a third modified example of the structure of the flow cell;

FIG. 2D is a cross-sectional view taken along line D-D′ of FIG. 2C;

FIG. 2E is a cross-sectional view taken along line E-E′ of FIG. 2C;

FIG. 3A is a photograph in a case where the array chip is actually incorporated in the flow cell having the structure illustrated in FIG. 2A;

FIG. 3B is a photograph in a case where the array chip is actually incorporated in the flow cell having the structure illustrated in FIG. 1C;

FIG. 4A is a diagram illustrating an ideal procedure when a solution to be inspected is supplied to a through-hole array;

FIG. 4B is a diagram illustrating an ideal procedure when the solution to be inspected is supplied to the through-hole array;

FIG. 5A is a diagram for describing problems that occur when liquid supply is performed;

FIG. 5B is a diagram for describing the problems that occur when the liquid supply is performed;

FIG. 6A is a photograph of an upper surface of the flow cell before the solution to be inspected is supplied;

FIG. 6B is a photograph of a bottom surface of the flow cell before the solution to be inspected is supplied;

FIG. 6C is a photograph of the upper surface of the flow cell after the solution to be inspected is supplied and air is supplied;

FIG. 6D is a photograph of the bottom surface of the flow cell after the supply of the solution to be inspected and the air is supplied;

FIG. 7A is a diagram illustrating a liquid supply method to an array chip according to the first embodiment;

FIG. 7B is a diagram illustrating the liquid supply method to the array chip according to the first embodiment;

FIG. 8 is a top view of the flow cell in a state where a liquid supply pipe is connected;

FIG. 9A is a diagram for describing movement of a fluid in the liquid supply pipe in a case where an inner diameter of the liquid supply pipe is large;

FIG. 9B is a diagram for describing the movement of the fluid in the liquid supply pipe in a case where the inner diameter of the liquid supply pipe is small;

FIG. 10A is a diagram illustrating a force due to gravity applied to the solution and oil during liquid supply;

FIG. 10B is a diagram for describing a state of the solution to be inspected near a lower side of a through-hole;

FIG. 10C is a diagram for describing a state of the solution to be inspected near the lower side of the through-hole;

FIG. 11 is a diagram for more accurately describing the force applied to the solution to be inspected on the upper side of the array chip;

FIG. 12 is a diagram for simplifying and describing the force applied to the solution to be inspected on the upper side of the array chip;

FIG. 13 is a diagram illustrating a modified example of the liquid supply pipe;

FIG. 14A is a diagram illustrating a liquid supply method to an array chip according to a second embodiment;

FIG. 14B is a diagram illustrating the liquid supply method to the array chip according to the second embodiment;

FIG. 15 is a diagram for describing a timing at which the solution to be inspected and the array chip come into contact with each other;

FIG. 16A is a diagram illustrating a liquid supply method to an array chip according to a modified example of the second embodiment;

FIG. 16B is a diagram illustrating a liquid supply method to an array chip according to a modified example of the second embodiment;

FIG. 17A is a diagram illustrating a liquid supply method to an array chip according to a third embodiment;

FIG. 17B is a diagram illustrating the liquid supply method to the array chip according to the third embodiment;

FIG. 17C is a diagram illustrating the liquid supply method to the array chip according to the third embodiment;

FIG. 17D is a diagram illustrating the liquid supply method to the array chip according to the third embodiment;

FIG. 18A is a diagram illustrating a liquid supply method to an array chip according to a fourth embodiment;

FIG. 18B is a diagram illustrating the liquid supply method to the array chip according to the fourth embodiment;

FIG. 19 is a diagram illustrating a structure of a liquid supply pipe according to a fifth embodiment;

FIG. 20A is a diagram illustrating a liquid supply method to an array chip according to a sixth embodiment;

FIG. 20B is a diagram illustrating the liquid supply method to the array chip according to the sixth embodiment;

FIG. 21 is a diagram illustrating a liquid supply method to an array chip according to a seventh embodiment;

FIG. 22 is a diagram for describing a PCR reaction and a method of fluorescence observation according to an eighth embodiment;

FIG. 23 is a schematic diagram illustrating an example of a result of fluorescence observation;

FIG. 24 is a diagram illustrating a flow cell in which an array chip is incorporated after a liquid supply method according to a ninth embodiment is performed;

FIG. 25A is a cross-sectional view of an array chip including an array of wells;

FIG. 25B is a cross-sectional view of an array chip having an array of hydrophilic spots;

FIG. 26 is a diagram illustrating a liquid supply method to an array chip according to a tenth embodiment;

FIG. 27 is a diagram illustrating the liquid supply method to the array chip according to the tenth embodiment;

FIG. 28A is a diagram illustrating a liquid supply method to an array chip according to an eleventh embodiment;

FIG. 28B is a diagram illustrating the liquid supply method to the array chip according to the eleventh embodiment;

FIG. 29A is a diagram illustrating a liquid supply method to an array chip according to Example 1;

FIG. 29B is a diagram illustrating the liquid supply method to the array chip according to Example 1;

FIG. 30A is a cross-sectional view of a flow cell in a state where a liquid supply pipe is connected;

FIG. 30B is a top view of a state of FIG. 30A;

FIG. 31A is a photograph of a front surface of a flow cell after liquid supply in Example 1 is performed; and

FIG. 31B is a photograph of a back surface of the flow cell after liquid supply in Example 1 is performed.

### DESCRIPTION OF THE PREFERRED EMBODIMENTS

Hereinafter, embodiments of the present disclosure will be described with reference to the drawings. In all the drawings for describing the embodiments of the present disclosure, components having the same function are denoted by the same reference signs, and redundant description thereof will be omitted as far as possible. The structures and materials described in the embodiments are examples for embodying the idea of the present disclosure, and are not intended to strictly specify materials, dimensions, detailed structures, and the like. In particular, the dimensions and scales of the drawings are not accurate due to a preference for visibility.

### First Embodiment

### Configuration Example of Array Chip

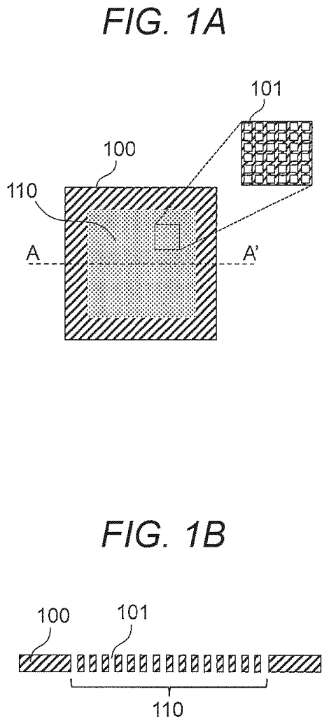

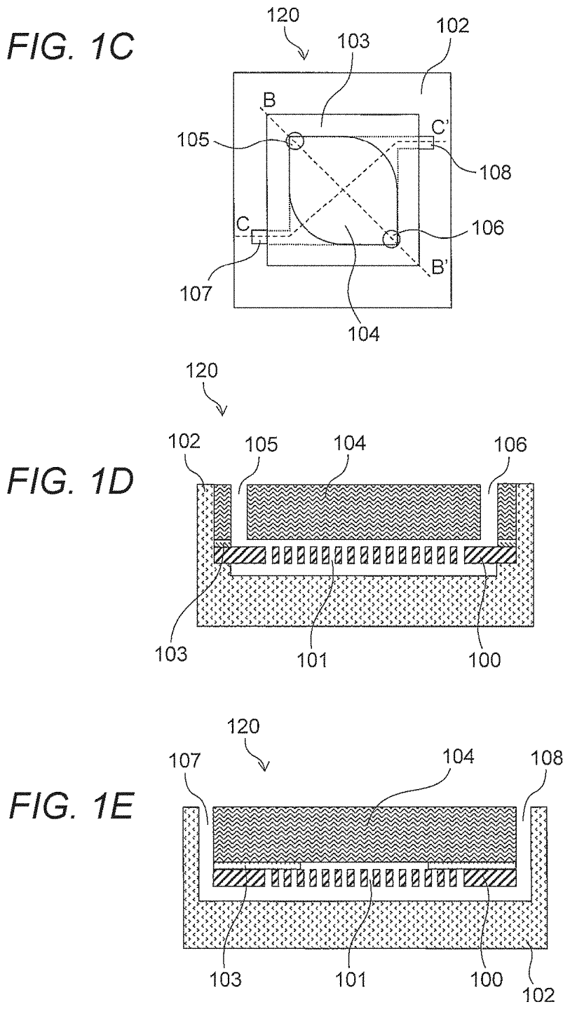

FIG. 1A is a top view of an array chip 100. The array chip 100 has a through-hole array 110 in a central portion thereof in which through-holes 101 are arrayed. A material of the array chip 100 may be, for example, Si whose front surface is oxidized, or may be glass. A shape of an upper surface of the through-hole 101 is not limited to a quadrangle, and may be, for example, a circle, a hexagon, or another polygon. A density of the through-holes 101 can be, for example, about 170 holes/mm².

FIG. 1B is a cross-sectional view taken along line A-A′ of FIG. 1A. A thickness of the array chip 100 can be, for example, 300 μm.

### Configuration Example of Flow Cell

FIG. 1C is a top view of a state where the array chip 100 is incorporated in a flow cell 120. The flow cell 120 includes a lower part 102, a spacer 103, an upper part 104, an introduction port 105, a discharge port 106, an introduction port 107, and a discharge port 108. The introduction port 105 and the discharge port 106 are provided in the upper part 104. The introduction port 107 and the discharge port 108 are provided in the lower part 102. A material of the lower part 102 can be, for example, zinc, aluminum, glass, acrylic, polycarbonate, or other plastic materials. The upper part 104 is a transparent member. A material of the upper part 104 can be, for example, glass, acrylic, polycarbonate, or other plastic materials. The spacer 103 is provided between the array chip 100 and the upper part 104, and defines a lemon-shaped space in top view. As described above, since the space defined by the spacer 103 has a rounded lemon shape, a fluid supplied to the space can efficiently permeate.

FIG. 1D is a cross-sectional view taken along line B-B′ of FIG. 1C. As illustrated in FIG. 1D, a lower surface of an end portion of the array chip 100 is supported by the lower part 102. The array chip 100 and the lower part 102 are bonded to each other by using, for example, an adhesive. The array chip 100 can be incorporated into the flow cell 120 by disposing the spacer 103 on the array chip 100 and disposing the upper part 104 on the spacer 103. A thickness of the spacer 103 determines a distance between the array chip 100 and the upper part 104. The spacer 103 can be, for example, a double-sided tape having a thickness of about 100 μm. The introduction port 105 and the discharge port 106 are communicatively connected to a space on an upper side of the array chip 100. A fluid (liquid or gas) can be supplied from the introduction port 105 to the upper side of the array chip 100 and can be discharged from the discharge port 106.

FIG. 1E is a cross-sectional view taken along line C-C′ of FIG. 1C. The introduction port 107 and the discharge port 108 are communicatively connected to a space on a lower side of the array chip 100. A fluid can be supplied from the introduction port 107 to the lower side of the array chip 100 and can be discharged from the discharge port 108. A distance between the lower surface of the array chip 100 and the lower part 102 can be, for example, 300 μm.

### Another Configuration Example of Flow Cell

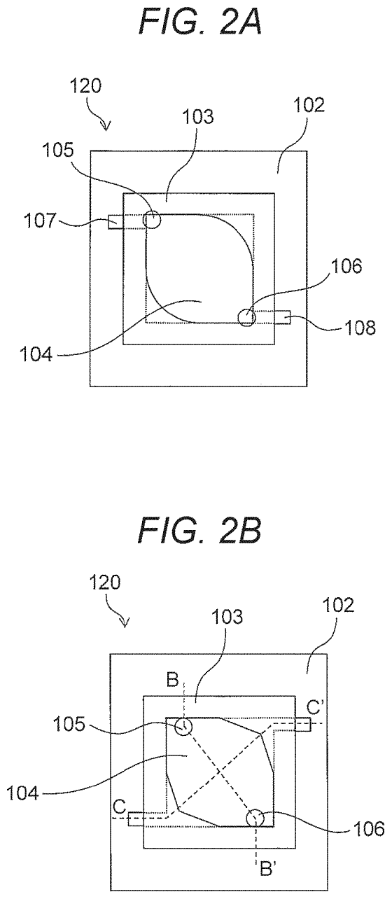

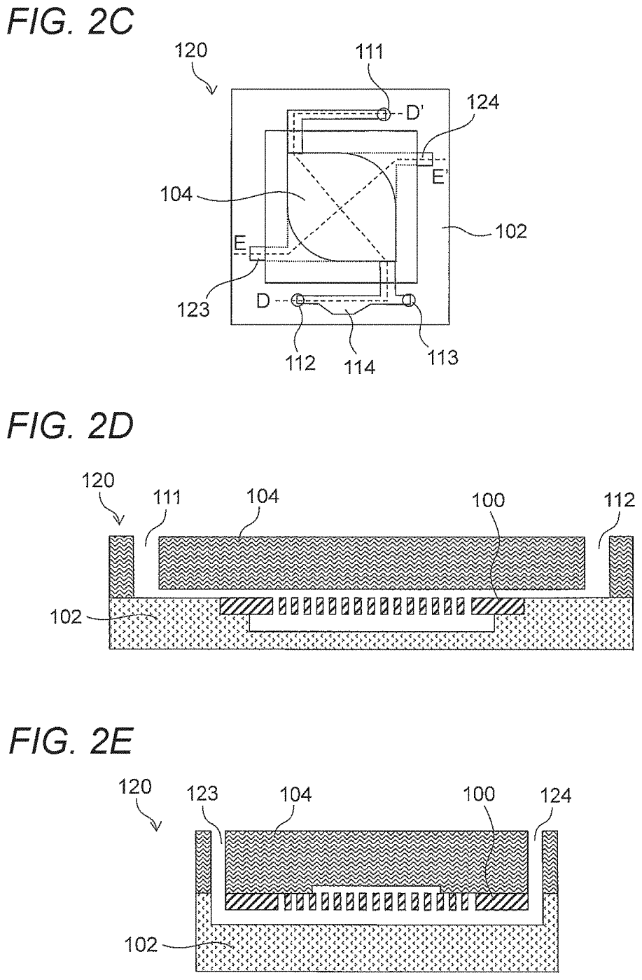

FIG. 2A is a top view illustrating a first modified example of a structure of the flow cell 120. In the example of FIG. 2A, the introduction port 105 and the discharge port 106 for introducing and discharging the fluid to and from the upper side of the array chip 100 are disposed at positions (on the same diagonal line) close to the introduction port 107 and the discharge port 108 for introducing and discharging the fluid to and from the lower side of the array chip 100.

FIG. 2B is a top view illustrating a second modified example of the structure of the flow cell 120. In the example of FIG. 2B, the introduction port 105 and the discharge port 106 for introducing and discharging the fluid to and from the upper side of the array chip 100 are not disposed on the diagonal line of the array chip 100, and are disposed at positions shifted from corners of the array chip 100. In the example of FIG. 2B, an opening of the spacer 103 (the space defined by the spacer 103) is not rounded but cut into a polygonal shape.

FIG. 2C is a top view illustrating a third modified example of the structure of the flow cell 120. In the example of FIG. 2C, while one introduction port 111 for introducing the fluid is provided on the upper side of the array chip 100, two discharge ports 112 and 113 for discharging the fluid on the upper side of the array chip 100 are provided. In FIG. 2C, a bulging shape 114 is provided in the middle of a flow path toward the discharge port 112.

FIG. 2D is a cross-sectional view taken along line D-D′ of FIG. 2C. As illustrated in FIG. 2D, the introduction port 111 and the discharge port 112 are formed in the upper part 104, and the introduction port 111 and the discharge port 112 are communicatively connected to the space on the upper side of the array chip 100.

FIG. 2E is a cross-sectional view taken along line E-E′ of FIG. 2C. As illustrated in FIG. 2E, an introduction port 123 and a discharge port 124 are formed by openings provided in the upper part 104, and the introduction port 123 and the discharge port 124 are communicatively connected to the space on the lower side of the array chip 100.

The structure of the flow cell 120 is not limited to the structures illustrated in FIGS. 1C and 2A to 2E, and may be another structure.

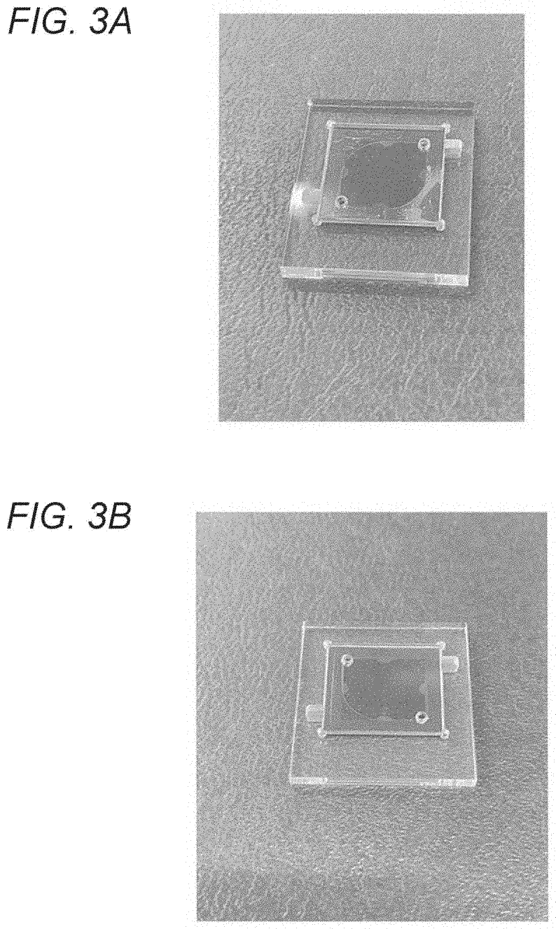

FIG. 3A is a photograph in a case where the array chip is actually incorporated in the flow cell having the structure illustrated in FIG. 2A. A lemon-shaped space is defined at the central portion of the flow cell illustrated in FIG. 3A. This lemon-shaped space is sealed, and the fluid is supplied to this space.

FIG. 3B is a photograph in a case where the array chip is actually incorporated in the flow cell having the structure illustrated in FIG. 1C. Similarly to FIG. 3A, a lemon-shaped space is also defined in the central portion of the flow cell in FIG. 3B.

### Ideal Liquid Supply Procedure

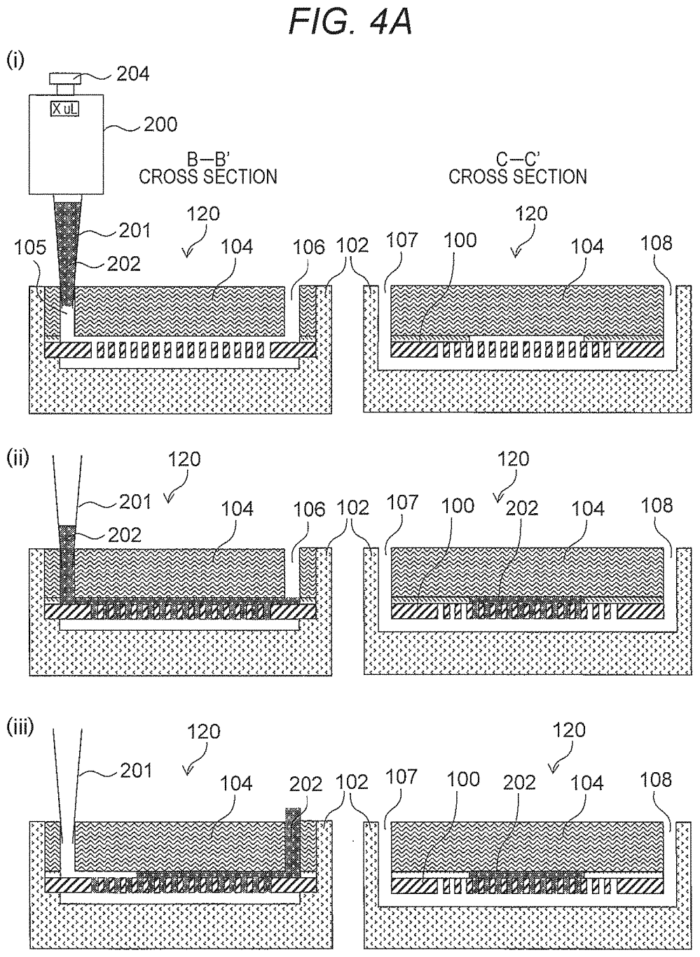

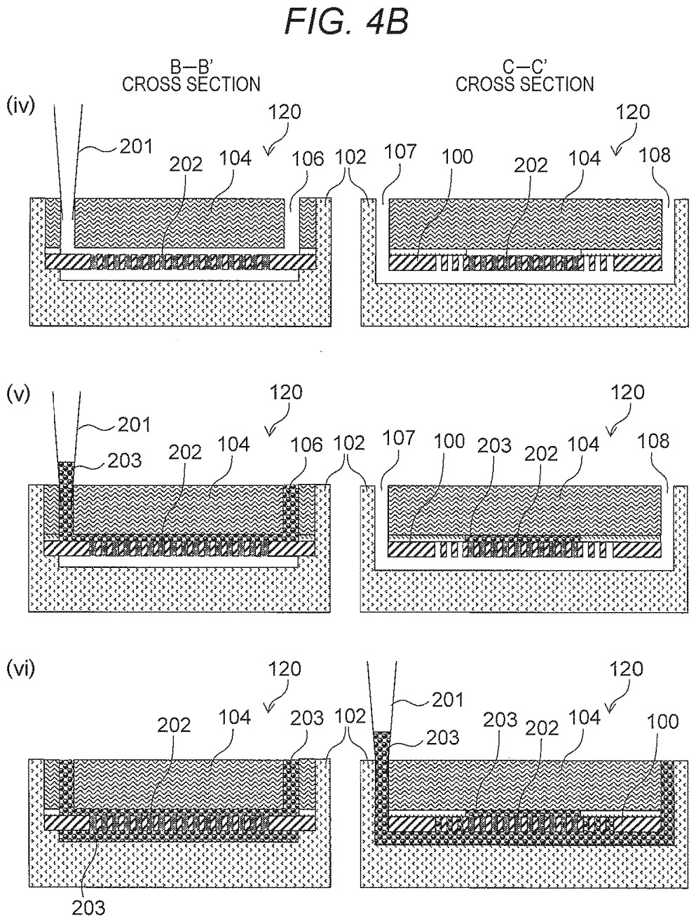

FIGS. 4A and 4B are diagrams illustrating an ideal procedure when a solution to be inspected is fractionated into the through-hole array 110 of the array chip 100. Hereinafter, in the description of the liquid supply procedure to the array chip 100, a case where the flow cell 120 having the structure illustrated in FIGS. 1C to 1E is used will be described as a representative.

Step (i) of FIG. 4A illustrates a state immediately before the supply of a solution 202 to be inspected. First, as illustrated in step (i) of FIG. 4A, an operator fills a distal end portion 201 of a pipette 200 with the solution 202 to be inspected, and connects the pipette to the introduction port 105. Thereafter, the operator extrudes the solution 202 to be inspected by pressing a push button 204 by hand. Accordingly, as in step (ii), the solution 202 to be inspected is supplied to the upper side of the array chip 100 and into each through-hole 101. A main body portion of the pipette 200 is representatively drawn only in step (i), and is omitted in step (ii) and subsequent steps.

Subsequently, as illustrated in step (iii), the operator fills the distal end portion 201 of the pipette 200 with air and connects the pipette to the introduction port 105. Thereafter, the operator extrudes the air by pressing the push button 204. Accordingly, as in step (iv) of FIG. 4B, the solution 202 to be inspected on the upper side of the array chip 100 is replaced with the air. The solution 202 to be inspected overflowing from the discharge port 106 due to the supply of the air is discarded. At this time, the solution 202 to be inspected remains in each through-hole 101 due to surface tension.

Subsequently, as illustrated in step (v), the operator fills the distal end portion 201 of the pipette 200 with oil 203 and connects the pipette to the introduction port 105. Thereafter, the operator extrudes the oil 203 by pressing the push button 204. Accordingly, the upper side of the array chip 100 is filled with the oil 203.

Finally, as illustrated in step (vi), the operator fills the distal end portion 201 of the pipette 200 with the oil 203, and connects the pipette to the introduction port 107. Thereafter, the operator extrudes the oil 203 by pressing the push button 204. Accordingly, the lower side of the array chip 100 is filled with the oil 203.

As in the above steps (i) to (vi), a structure in which the solution 202 to be inspected is fractionated into the through-holes 101, and the upper side and the lower side of the solution 202 to be inspected in each through-hole 101 are covered with the oil 203 is formed. Thereafter, the flow cell 120 in which the array chip 100 is incorporated is installed in a thermal cycler, and a PCR reaction is performed. After completion of the PCR reaction, fluorescence observation of the array chip 100 from the upper surface side is performed, and thus, it can be seen whether or not a DNA sequence to be detected is present in the solution 202 to be inspected. Detailed methods of the PCR and the fluorescence observation are as described in [Description of the Related Art]. Since the upper side and the lower side of the solution 202 to be inspected present in the through-hole array 110 are covered with the oil 203, the solution 202 to be inspected present in the adjacent through-holes 101 is basically not mixed during the PCR reaction.

According to the method of FIGS. 4A and 4B, the upper side of the array chip 100 is not largely opened to the atmosphere, including during and before and after liquid supply. Accordingly, as compared with the method using the loader as in JP 2015-512508 A, there is a low risk that the foreign matters (particles), the DNA, and the like floating in the atmosphere are mixed into the through-hole array 110 during liquid supply and before and after liquid supply. Since the loader is not used, the filling rate of the solution to be inspected into each through-hole does not change or there are no through-holes partially that are not filled due to a variation in an angle or a position at which the loader comes into contact with the front surface of the array chip. Accordingly, a yield of the inspection of the dPCR is improved, and high inspection accuracy can be secured. Since the pipette 200 is manually operated, a device using electric power is not required to fill the through-hole array 110 with the solution 202 to be inspected. Thus, as compared with JP 2015-512508 A and Xu Gao, et al., Biomicrofluidics 14, 034109 (2020); https://doi.org/10.1063/5.0006374 using the syringe pump, the solution to be inspected can be fractionated into each through-hole in an energy-saving and simple manner.

### Problems in Liquid Supply

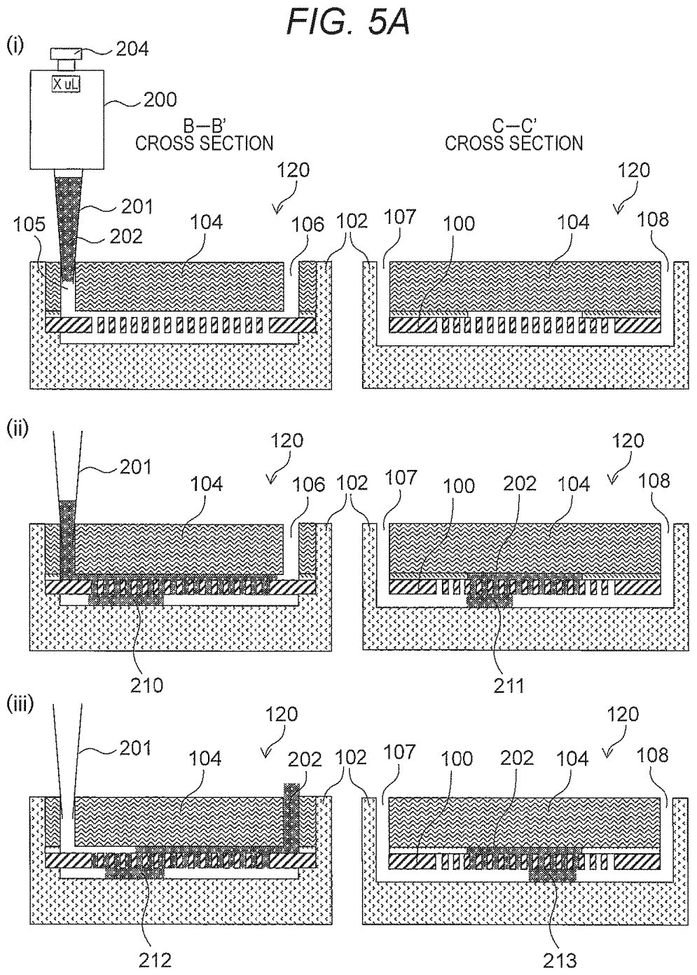

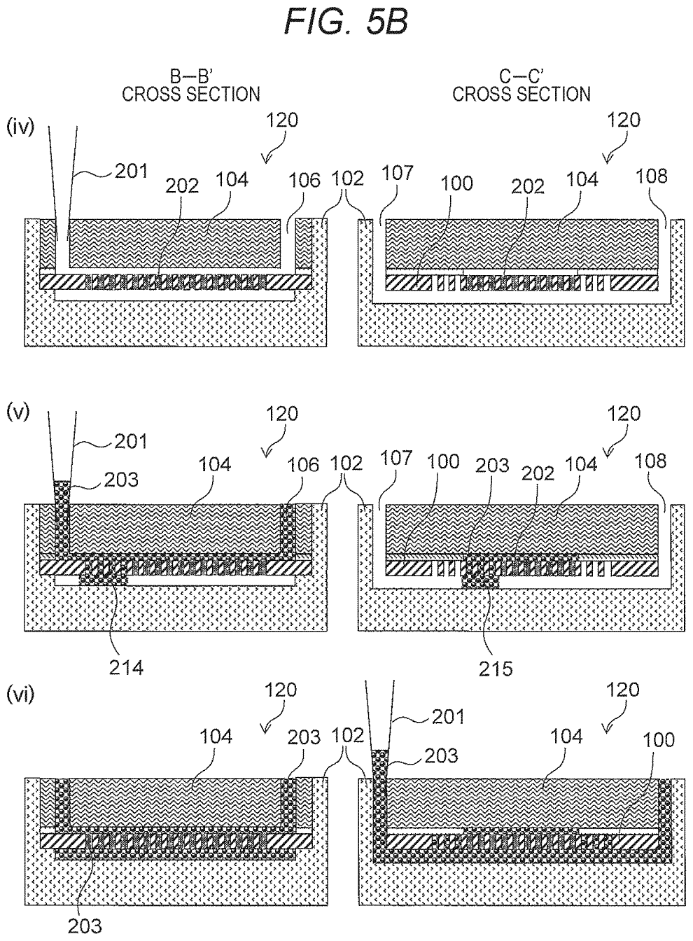

FIGS. 5A and 5B are diagrams for describing problems that occur when the method illustrated in FIGS. 4A and 4B is executed. The main body portion of the pipette 200 is representatively drawn only in step (i) of FIG. 5A, and is omitted in step (ii) and subsequent steps. According to the method of FIGS. 4A and 4B, the pipette 200 is manually operated during liquid supply and air supply to extrude the solution and the air. Thus, there are variations in speed and force during extrusion. In a case where the extrusion speed is too fast or the extrusion force is too strong, a strong pressure is applied to the solution in the flow cell. When this force is too strong, the solution 202 to be inspected that remains in the through-hole 101 due to the surface tension cannot continue to remain due to the surface tension, and leaks out below the through-hole 101. In step (ii), solutions 210 and 211 leaking out below the through-holes 101 are illustrated. The solutions 202 to be inspected filled in the different through-holes 101 are connected by the solutions 210 and 211. This is a problem in the dPCR measurement. This is because even though there is originally the DNA sequence to be detected only in a certain through-hole 101, in a case where the solution 202 in the through-hole 101 is connected to the solution 202 in a plurality of another through-holes 101, there are the amplified DNA sequences to be detected in all the through-holes 101 (that is, the through-holes 101 in which the solutions are connected) after the PCR reaction. By doing this, in the fluorescence observation after the PCR, fluorescence suggesting the presence of the DNA sequence to be detected is observed from all of these through-holes 101. In the dPCR, usually, the number of DNA sequences to be detected in an aqueous solution to be inspected is counted by counting the number of through-holes in which fluorescence is observed. However, as described above, when the solutions in the through-holes are connected to each other and the DNA sequence to be detected to be proliferated in one through-hole spreads over the plurality of through-holes, the accuracy of counting (accuracy of counting the number of DNA sequences to be detected originally present in the aqueous solution to be inspected) decreases.

As illustrated in step (iii), the solution may leak out below the through-holes 101 also when the air is supplied. In a case where the extrusion speed and the extrusion force of the air by the pipette 200 vary, and the extrusion speed is too fast or the extrusion force is too strong, a strong pressure is applied to the solution 202 in the flow cell 120. As a result, the solution cannot remain in the through-hole 101 due to the surface tension and leaks out below the through-holes 101. In step (iii), solutions 212 and 213 leaking out below the through-holes 101 are illustrated.

As illustrated in step (v) of FIG. 5B, the liquid may leak out below the through-holes 101 also during the injection of the oil 203. Similarly, in a case where the extrusion speed and extrusion force of the oil 203 by the pipette 200 vary, and the extrusion speed is too fast or the extrusion force is too strong, a strong pressure is applied to the oil 203 in the flow cell 120. As a result, the solution 202 present in the through-hole 101 cannot remain in the through-hole 101 due to the surface tension, and leaks out together with the oil 203 below the through-hole 101. In step (v), solutions 214 and 215 leaking out together with the solution 202 and the oil 203 are illustrated. As illustrated in step (vi), when the solution 202 or the oil 203 leaks out, the solutions 202 in the adjacent through-holes 101 are connected with the leaked solutions, or the through-holes 101 filled with the oil 203 are present. As a result, the yield of the inspection decreases.

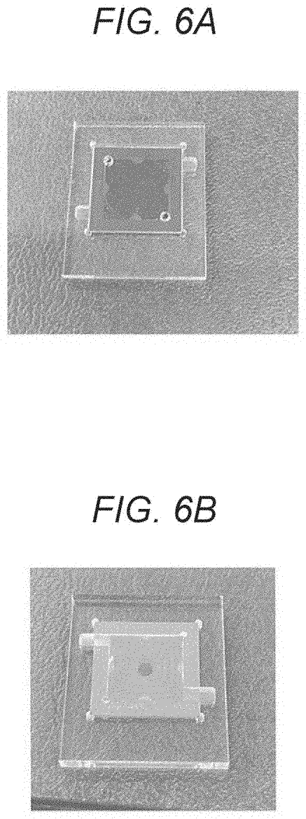

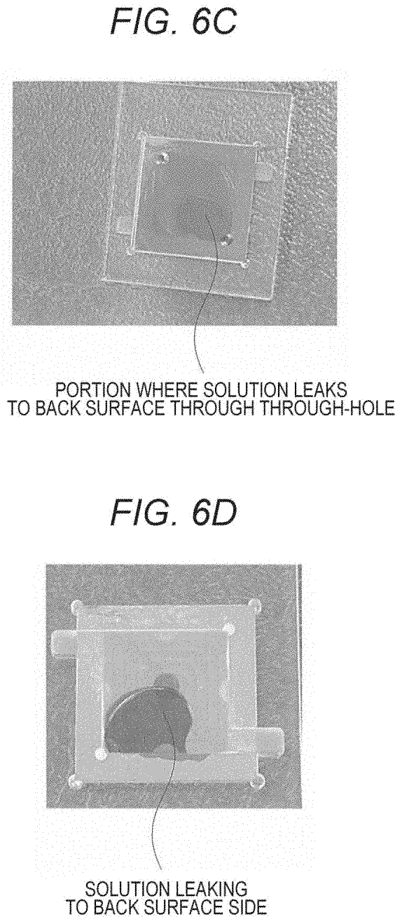

FIG. 6A is a photograph of an upper surface of the flow cell before the solution is supplied. FIG. 6B is a photograph of a back surface of the flow cell before the solution is supplied. FIG. 6C is a photograph of the upper surface of the flow cell after steps (i) to (iv) illustrated in FIGS. 4A and 4B are performed. FIG. 6D is a photograph of the back surface of the flow cell after steps (i) to (iv) illustrated in FIGS. 4A and 4B are performed. As illustrated in FIGS. 6C and 6D, it can be confirmed that the solution to be inspected introduced from the front surface side of the array chip 100 leaks out to the back surface through the through-holes and the liquids in the different through-holes are connected to each other. This is because since the pipette is manually operated, the extrusion force and the extrusion speed during the liquid supply and the air supply vary, and as a result, the extrusion force is too strong or the extrusion speed is too fast, and the solution in the through-hole is extruded below the through-hole.

In Xu Gao, et al., Biomicrofluidics 14, 034109 (2020); https://doi.org/10.1063/5.0006374, the solution to be inspected and the air are supplied to the flow path (flow cell) at a constant low speed by using the syringe pump instead of the manual operation using the pipette. Accordingly, the solution in the through-hole is not extruded below the through-hole, and the through-hole is filled with the solution to be inspected. However, electric power is required to drive the syringe pump. Since the size of the syringe pump is considerably larger than the size of the flow cell, a large work space is required for supplying the liquid to the flow cell. Accordingly, a method for filling the through-hole array with the solution in an energy-saving and simple manner without using electric power is desired.

### Liquid Supply Procedure According to First Embodiment

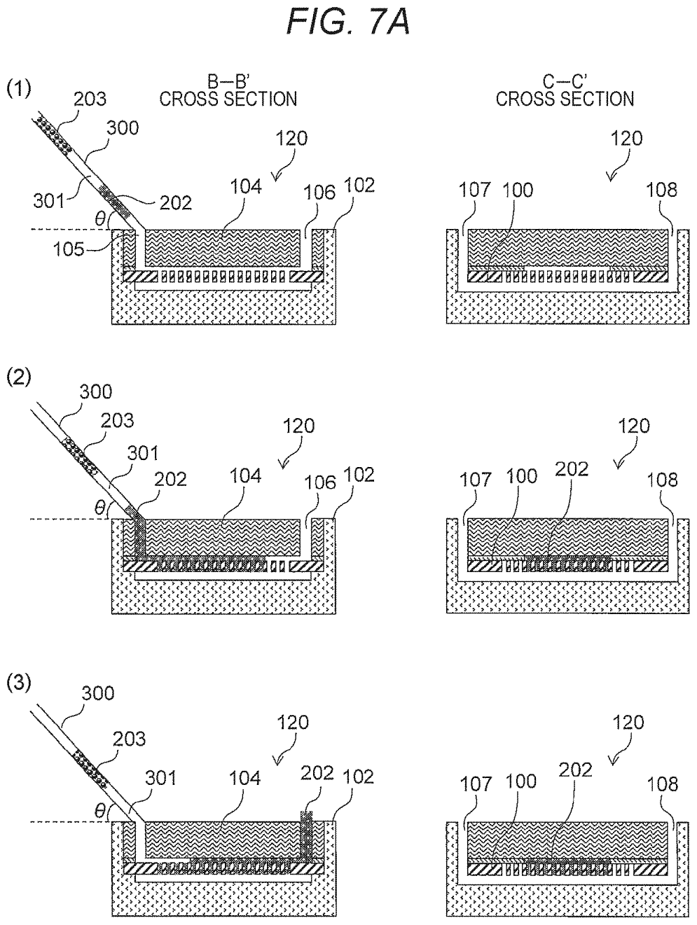

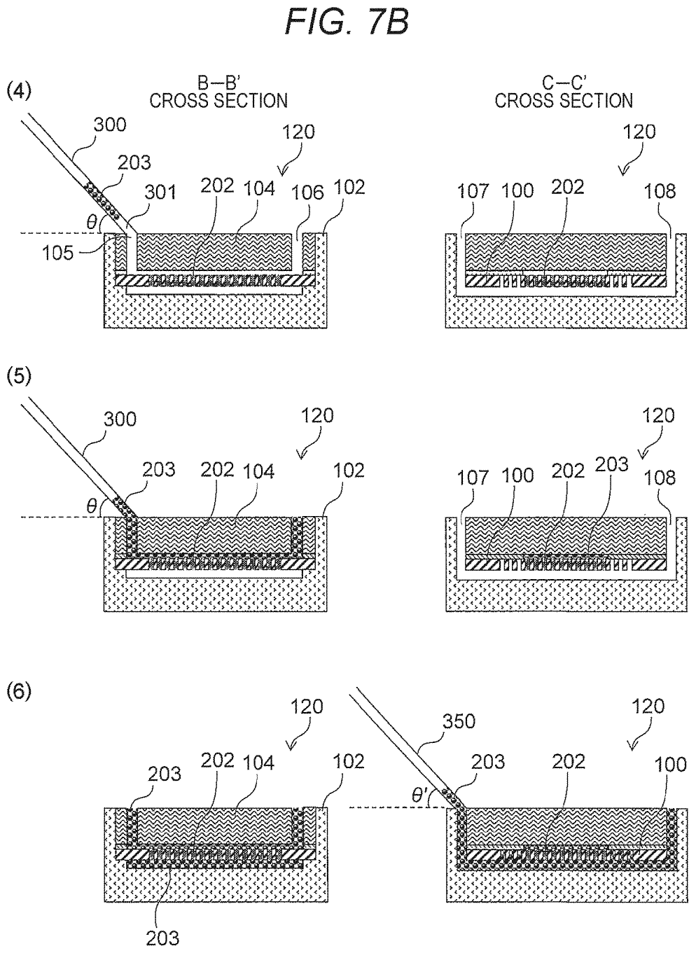

FIGS. 7A and 7B are diagrams illustrating a liquid supply method to the array chip 100 according to the first embodiment. In the present embodiment, a method of supplying the solution 202 to be inspected, the air, and the oil 203 to the flow cell 120 by using a liquid supply pipe will be described.

First, as illustrated in step (1) of FIG. 7A, the operator prepares a liquid supply pipe 300 filled with the solution 202 to be inspected, air 301 separating the solution 202 to be inspected and the oil 203, and the oil 203 in advance. The liquid supply pipe 300 may have flexibility or may have rigidity. Next, the operator connects the liquid supply pipe 300 to the introduction port 105 such that the solution 202 to be inspected is positioned on the side (lowermost) closest to the array chip 100. The flow cell 120 in which the array chip 100 is incorporated is installed substantially horizontally. An angle between the flow cell 120 and the liquid supply pipe 300 is defined as θ (0°≤θ≤90°). That is, the angle θ is an approximate angle of the liquid supply pipe 300 with respect to a horizontal plane. After setting to the state illustrated in step (1), almost no operation is required up to step (5) in FIG. 7B.

In step (2) of FIG. 7A, the solution 202 to be inspected is filled on the upper side of the array chip 100 and the through-holes 101 in the array chip 100 by gravity applied to the solution 202 to be inspected and the oil 203. Thereafter, in step (3) of FIG. 7A, the air 301 in the liquid supply pipe 300 is extruded to the flow cell by the gravity applied to the oil 203, and the air 301 extrudes (replaces) the solution 202 to be inspected present on the upper side of the array chip 100. At this time, the operator discards the solution overflowing from the discharge port 106. In step (4) of FIG. 7B, the solution 202 to be inspected that was present on the upper side of the array chip 100 is completely replaced with the air 301. Thereafter, in step (5) of FIG. 7B, the oil 203 enters the flow cell by the gravity applied to the oil 203, and the upper side of the array chip 100 is filled with the oil 203. Thereafter, in step (6) of FIG. 7B, the operator connects a liquid supply pipe 350, filled with the oil 203 in advance, to the introduction port 107 at an angle θ′. Accordingly, the oil 203 enters the flow cell by the gravity applied to the oil 203, and the lower side of the array chip 100 is filled with the oil 203. The angle θ′ may be the same as or different from the angle θ. As described above, in the liquid supply in steps (1) to (6) illustrated in FIGS. 7A and 7B, a power source of the fluid is gravity, and the electric power is not used. Such liquid supply by the gravity can be realized by the presence of two air holes of the introduction port 105 and the discharge port 106 on the upper side of the array chip 100 and the presence of two air holes of the introduction port 107 and the discharge port 108 on the lower side of the array chip 100. In other words, when the liquid is supplied from one air hole, the other air hole is released to the atmosphere, thereby the liquid supply by the gravity is achieved.

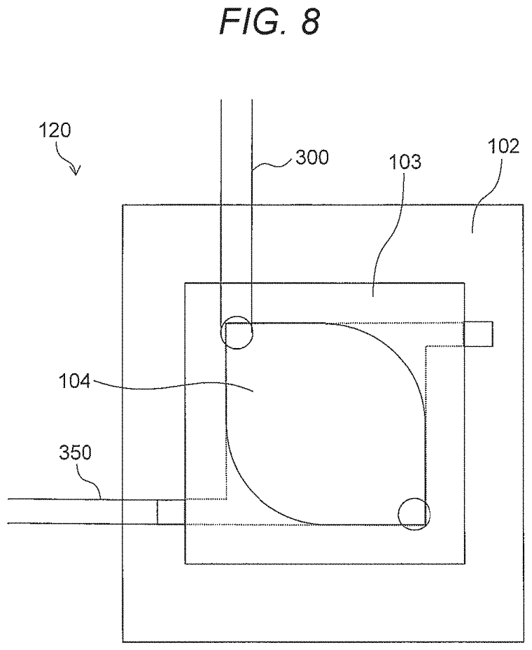

FIG. 8 is a top view of the flow cell 120 in a state where the liquid supply pipes 300 and 350 are connected. In step (6) of FIG. 7B, although a scene where the liquid supply pipe 300 is pulled out from the introduction port 105 and then the liquid supply pipe 350 is connected to the introduction port 107 is illustrated, the liquid supply pipe 350 may be connected to the introduction port 107 while the liquid supply pipe 300 is connected to the introduction port 105.

### About Role of Air Layer

In the liquid supply method of the present embodiment, the layer of the air 301 is important. From step (3) to step (4), the solution 202 to be inspected present on the upper side of the array chip 100 once disappears and is replaced with the air. Accordingly, the front surface (upper surface) of the array chip 100 other than the inside of the through-hole 101 is dried, and the solution 202 to be inspected disappears from the front surface of the array chip 100. Therefore, even though the PCR reaction is performed after the front surface and the back surface of the array chip 100 are filled with the oil 203, the solutions 202 to be inspected in the adjacent through-holes 101 are not mixed during the PCR.

On the other hand, in a case where there is no layer of the air 301 between the solution 202 to be inspected and the oil 203, there is no step of evaporating the solution 202 to be inspected from the front surface of the array chip 100 and drying the front surface of the array chip 100. Thus, the oil 203 is supplied to the upper side and the lower side of the array chip 100 while the solution 202 to be inspected remains on the front surface of the array chip 100 (that is, the solutions in the adjacent through-holes 101 remain connected on the front surface of the array chip 100 between the through-holes 101). Since the upper and lower surfaces of the array chip 100 are covered with the oil 203 after the supply of the oil 203, the solution 202 to be inspected cannot be evaporated or moved, and the solutions in the adjacent through-holes remain connected during the PCR reaction. This is a problem in the dPCR measurement. This is because even though there is originally the DNA sequence to be detected only in a certain through-hole, in a case where the solution in the through-hole is connected to the solution in the plurality of another through-holes, there are amplified DNA sequences to be detected in all the through-holes (that is, the through-holes in which the solutions are connected) after the PCR reaction. By doing this, in the fluorescence observation after the PCR, fluorescence suggesting the presence of the DNA sequence to be detected is observed from all of these through-holes. In the dPCR, usually, the number of DNA sequences to be detected in an aqueous solution to be inspected is counted by counting the number of through-holes in which fluorescence is observed. However, as described above, when the solutions in the plurality of through-holes are connected to each other and the DNA sequence to be detected to be proliferated in one through-hole spreads over the plurality of through-holes, the accuracy of counting (accuracy of counting the number of DNA sequences to be detected originally present in the aqueous solution to be inspected) decreases. About Conditions for Inner Diameter of Liquid Supply Pipe

The liquid is supplied to satisfy conditions to be described below, and thus, the liquid can be ideally supplied as in steps (1) to (6) illustrated in FIGS. 7A and 7B. One of the conditions is that an inner diameter of the liquid supply pipe 300 is smaller than 2.5 mm.

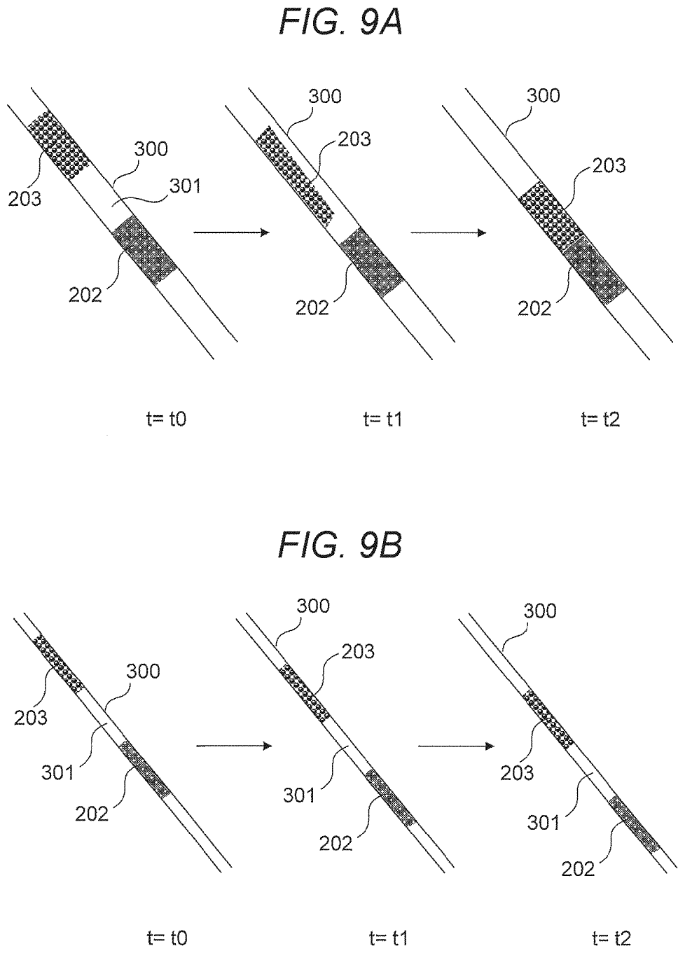

FIG. 9A is a diagram for describing the movement of the fluid in the liquid supply pipe 300 in a case where the inner diameter of the liquid supply pipe 300 is large. Here, the liquid supply pipe 300 is inclined by the angle θ with respect to the horizontal plane. In a case where the inner diameter of the liquid supply pipe 300 is large, even though there is the layer of the air 301 between the solution 202 to be inspected and the oil 203 at the beginning (at a certain time t=t0), the oil 203 cannot maintain an original shape in the liquid supply pipe 300, and enters a collapsing state drawn at t=t1 after a lapse of a certain period of time. This is because the oil 203 has a low surface tension, a small contact angle with respect to the liquid supply pipe 300, and a weak adhesive force with a wall surface of the liquid supply pipe 300. Since the oil 203 has a weak frictional force with an inner wall of the liquid supply pipe 300, a speed at which the oil falls downward is high. As a result, the oil enters a state drawn at t=t2, that is, a state where the solution 202 to be inspected and the oil 203 stick to each other and there is no layer of the air therebetween. The solution 202 to be inspected is usually an aqueous solution, and has a stronger surface tension, a larger contact angle with respect to the liquid supply pipe 300, a larger adhesive force with the wall surface of the liquid supply pipe 300, and a stronger frictional force with the inner wall of the liquid supply pipe 300, compared with the oil 203 in many cases. Thus, even though the shape of the oil 203 collapses as in the diagram of t=t1, a situation in which the shape of the solution 202 to be inspected does not collapse may occur.

FIG. 9B is a diagram for describing the movement of the fluid in the liquid supply pipe 300 in a case where the inner diameter of the liquid supply pipe 300 is small. In a case where the inner diameter of the liquid supply pipe 300 is sufficiently small, the shape of the oil 203 does not collapse after a lapse of a certain period of time. This is because, in a case where the inner diameter of the liquid supply pipe 300 is sufficiently small, the oil 203 is energetically more stable when the oil is present in a form in which the shape does not collapse as drawn in t=t1 of FIG. 9B than when the oil is present in the collapsing form as drawn in t=t1 of FIG. 9A. Accordingly, in a case where the inner diameter of the liquid supply pipe 300 is sufficiently small, the solution 202 to be inspected and the oil 203 advance downward in the liquid supply pipe 300 by gravity, but at this time, the layer of the air 301 is constantly present between the solution 202 to be inspected and the oil 203.

The present inventors have conducted studies on a large number of oils and a large number of liquid supply pipes at various angles θ of 0 degrees or more and 90 degrees or less and resultantly have found that in a case where the inner diameter of the liquid supply pipe 300 is equal to or larger than 2.5 mm, the shape of the oil 203 collapses and the oil 203 and the solution 202 to be inspected stick to each other as illustrated in FIG. 9A. It has been found that in a case where the inner diameter of the liquid supply pipe 300 is smaller than 2.5 mm, the oil 203 and the solution 202 to be inspected may advance downward while the air between the oil 203 and the solution 202 to be inspected is held as illustrated in FIG. 9B. In particular, in a case where the inner diameter of the liquid supply pipe 300 is equal to or smaller than 1.5 mm, it has been found that the oil 203 and the solution 202 to be inspected advance downward while the air between the oil 203 and the solution 202 to be inspected is reliably held as illustrated in FIG. 9B.

Here, examples of the oil 203 include mineral oil, paraffin, silicone oil, Fluorinert, other fluorine-containing oils, and oils partially containing these oils as components. The oil 203 may contain one of these oils alone, or may contain two or more oils. Examples of a material of the liquid supply pipe 300 include fluorocarbon resin, silicone, PDMS, acrylic, rubber, elastomer, polyester, olefin, polyamide, urethane, polyurethane, polypropylene, vinyl chloride, polycarbonate, other plastic materials, and materials containing a portion of these materials as components. The material of the liquid supply pipe 300 may include one of these materials alone, or may include a plurality of materials.

As described above, from the studies of the present inventors, it has been found that when the inner diameter of the liquid supply pipe 300 is at least smaller than 2.5 mm, particularly equal to or smaller than 1.5 mm, the liquid can be supplied while the air between the oil and the solution to be inspected is maintained. The liquid supply pipe 300 may not have a perfect cylindrical shape. In this case, a cross-sectional area of a hollow portion of the liquid supply pipe 300 is set to be smaller than 2.5×2.5×n/4 mm², particularly equal to or smaller than 1.5×1.5×n/4 mm², it is possible to supply the liquid while the air between the oil and the solution to be inspected is maintained.

### About Conditions for Pressure in Flow Path

Hereinafter, conditions for a pressure in the flow path for ideal liquid supply as in steps (1) to (6) illustrated in FIGS. 7A and 7B will be described.

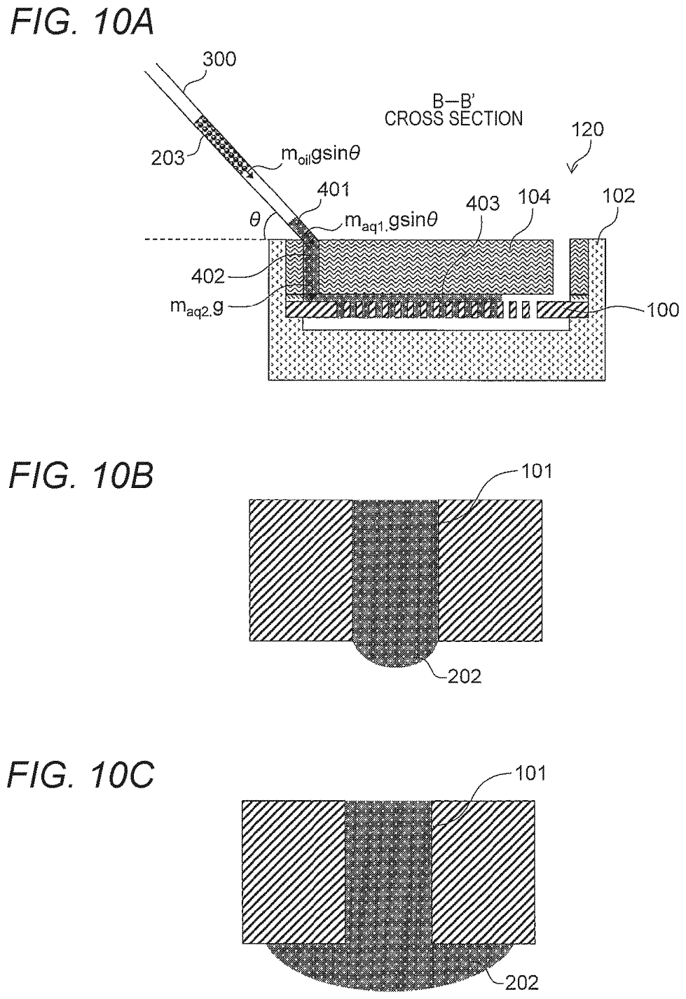

FIG. 10A is a diagram illustrating a force due to the gravity applied to the solution and the oil during the liquid supply. The solution to be inspected is divided into a portion 401, a portion 402, and the other portion 403 by dotted lines. A pressure applied to the portion 403 on the upper side of the array chip 100 in the solution to be inspected is determined by forces applied to the portion 403 by the portion 402, the portion 401, and the oil 203. In the case of FIG. 10A, there are a force m_{aq2}.g due to gravity applied to the portion 402, a force m_{aq1}.g sin θ due to gravity applied to the portion 401, and a force mₒᵢₗg sin θ due to gravity applied to the oil 203. Here, g is a gravitational acceleration, m_{aq1}. is a mass of the portion 401 of the solution to be inspected, m_{aq2}. is a mass of the portion 402 of the solution to be inspected, and mₒᵢₗ is a mass of the oil 203. Accordingly, the pressure on the portion 403 of the solution to be inspected becomes (mₒᵢₗg sin θ+m_{aq1}.g sin θ)/S₁+m_{aq2}.g/S₂. Here, S₁ is a cross-sectional area of the liquid supply pipe 300, and S₂ is a cross-sectional area of the portion 402 (that is, an area of a cross section of the introduction port 105 parallel to the front surface of the array chip 100).

FIGS. 10B and 10C are diagrams for describing a state of the solution 202 to be inspected near the lower side of the through-hole 101. Usually, the solution 202 near the lower side of the through-hole 101 remains due to the surface tension without falling down as illustrated in FIG. 10B. However, when a certain pressure or more is applied to the solution 202, a state where the solution 202 remains without falling down due to the surface tension cannot be maintained, and the solution 202 leaks out downward or in a left-right direction as illustrated in FIG. 10C. A threshold pressure at which the solution 202 leaks out is referred to as a “bursting pressure P_{B}”. That is, when a pressure equal to or higher than the bursting pressure P_{B} is applied to the solution 202, the solution 202 leaks out downward or in the left-right direction as illustrated in FIG. 10C. The bursting pressure P_{B} is determined by P_{B}=LGsin θ_{B}/A. Here, L is a circumferential length of a cross section of the through-hole, A is across-sectional area of the through-hole, σ is surface tension of the solution to be inspected, and θ_{B} is a contact angle of the solution 202 to be inspected with respect to the array chip 100. All of L, σ, θ_{B}, and A are measurable parameters. As illustrated in FIG. 10C, when the solution to be inspected leaks out downward or in the left-right direction, the solutions 202 to be inspected inside the adjacent through-holes are connected to each other. By doing this, the inspection accuracy of the dPCR decreases as described above.

Accordingly, when (mₒᵢₗg sin θ+m_{aq1}.g sin θ)/S₁+m_{aq2}.g/S₂<P_{B} (hereinafter, this inequality is referred to as “Condition 1”) is satisfied, the solution 202 to be inspected can be supplied without leaking out to the lower side and the left and right of the through-hole 101. That is, the pressure applied to the solution 202 to be inspected on the upper side of the array chip 100 may not exceed the bursting pressure P_{B} during the flow of FIGS. 7A and 7B. Preventing the pressure applied to the solution 202 to be inspected on the upper side of the array chip 100 from exceeding the bursting pressure P_{B} is possible by performing the adjustment of the amounts (masses) of the solution 202 to be inspected and the oil 203 to be filled in the liquid supply pipe 300 and the adjustment of the angle θ of the liquid supply pipe 300. Simply, the amount of the solution 202 to be inspected, the amount of the oil 203, and the angle θ of the liquid supply pipe 300 may be adjusted to satisfy Condition 1. Within the range satisfying Condition 1, the larger the angle θ, the faster the liquid supply speed. Thus, the liquid can be efficiently supplied.

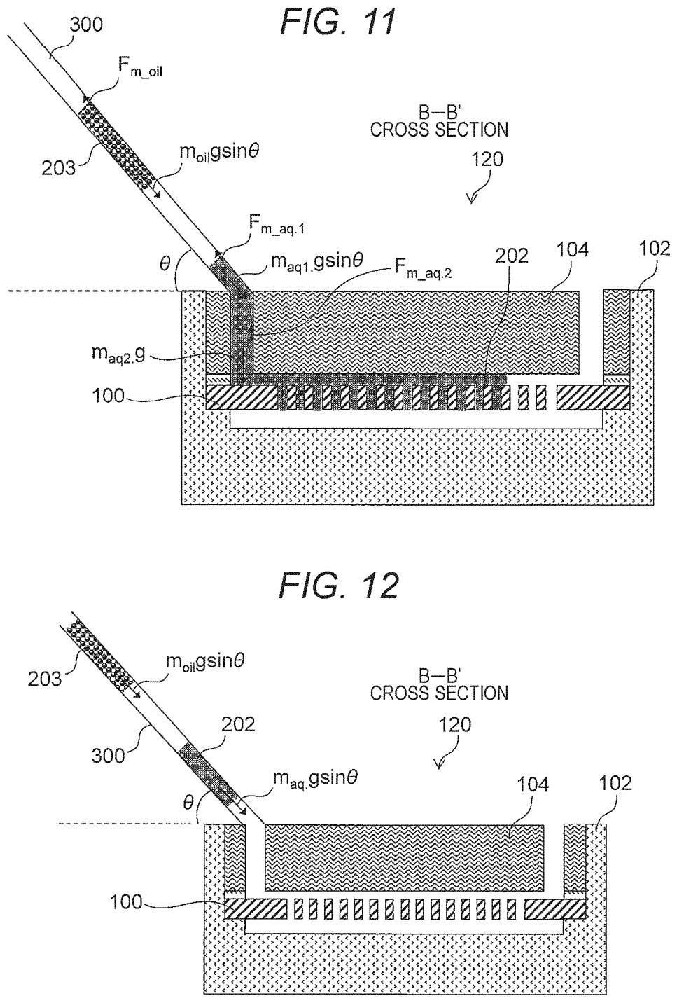

FIG. 11 is a diagram for more accurately describing the force applied to the solution 202 to be inspected on the upper side of the array chip 100. As illustrated in FIG. 11, a frictional force F_{m_oil} between the oil 203 and an inner wall surface of the liquid supply pipe 300, a frictional force F_{m_aq.1} between the solution 202 and the inner wall surface of the liquid supply pipe 300, and a frictional force F_{m_aq.2} between the solution 202 and an inner wall surface of the introduction port 105 (an inner wall surface of the opening of the upper part 104) can also be considered. In this case, the expression of Condition 1 is transformed into (mₒᵢₗg sin θ−F_{m_oil}+m_{aq1}.g sin θ−F_{m_aq.1})/S₁+(m_{aq2}.g−F_{m_aq.2})/S₂<P_{B} (hereinafter, this inequality is referred to as “Condition 2”). In consideration of the frictional force, the amounts of the solution 202 to be inspected and the oil 203 to be supplied to the liquid supply pipe 300 estimated under Condition 2 are larger than an allowable amount when the amounts are estimated under Condition 1. That is, as long as the inequality of Condition 1 is satisfied, Condition 2 is constantly satisfied, so only Condition 1 may be considered in a case where a simple estimation is desired.

FIG. 12 is a diagram for simplifying and describing the force applied to the solution 202 to be inspected on the upper side of the array chip 100. As illustrated in FIG. 12, in a starting state, that is, in a state where the solution 202 to be inspected and the oil 203 are only in the liquid supply pipe 300, when (mₒᵢₗg sin θ+m_{aq}.g sin θ)/S₁<P_{B} (hereinafter, this inequality is referred to as “Condition 3”. m_{aq}. is a mass of the solution 202 to be inspected) is satisfied, the solution 202 to be inspected can be supplied without leaking out to the lower side, the left and right of the through-hole 101 during the liquid supply.

More simply, since the bursting pressure P_{B} satisfies P_{B}=LGsin θ_{B}/A<Lσ/A, when (mₒᵢₗg sin θ+m_{aq}.g sin θ)/S₁<Lσ/A is satisfied in the starting state illustrated in FIG. 12, the solution 202 to be inspected can be supplied without leaking out to the lower side and the left and right of the through-hole 101.

Here, details of the amount of the air 301 will be described. Basically, in the present disclosure, it is sufficient that even a small amount of air 301 is held between the solution 202 to be inspected and the oil 203. However, more preferably, it is desirable that an amount of air 301 sufficient to realize the state of FIG. 7B(4) is present between the solution 202 to be inspected and the oil 203.

The state of FIG. 7B(4) is a state where the solution 202 to be inspected disappears from the upper side of the array chip 100 in the flow cell 120, the oil 203 does not yet come into contact with the array chip 100, and the air present on the upper side of the array chip 100 is connected to external air through the discharge port 106. In a state where the air present on the upper side of the array chip 100 is connected to the external air through the discharge port 106, the evaporation and drying of the excess solution 202 to be inspected remaining on the front surface of the array chip 100 are promoted. Thus, it is possible to greatly reduce a risk that the solutions 202 to be inspected inside the adjacent through-holes 101 are connected via the front surface of the array chip 100. As described above, the reduction of this risk leads to improvement of the inspection accuracy of the dPCR. As is clear from FIG. 7B, in order to create the state of FIG. 7B(4) described above, the amount of the air 301 needs to be larger than a total volume of a space through which the air and the liquid can flow (a total volume from the introduction port 105 to the discharge port 106) in a region of the flow cell 120 positioned on the upper side of the array chip 100.

Next, details of the amount of the oil 203 will be described. Of course, the amount of the oil 203 needs to be equal to or larger than the amount necessary to completely cover the front surface of the array chip 100. It is desirable that the mass of the oil 203 is larger than the mass of the solution 202 to be inspected filled in the liquid supply pipe 300. In a case where the mass of the oil 203 is smaller than the mass of the solution 202 to be inspected filled in the liquid supply pipe 300, in FIGS. 7A(3) to 7B(4), the solution 202 to be inspected is not completely extruded from the discharge port 106, and there is a possibility that the solution 202 to be inspected remains in the flow cell 120 and the flow stops on the way. On the other hand, in a case where the mass of the oil 203 is sufficiently larger than the mass of the solution 202 to be inspected filled in the liquid supply pipe 300, there is no such concern.

The supply of the oil 203 by the liquid supply pipe 350 to the back surface of the array chip 100 illustrated in FIG. 7B(6) will be described. There is no problem even though the mass and the angle θ′ of the oil 203 in the liquid supply pipe 350 are not necessarily adjusted such that the pressure applied to the oil present on the lower side of the array chip 100 does not exceed the bursting pressure P_{B}. This is because since the upper surface of the array chip 100 is already filled with the oil 203, the solution 202 to be inspected in the through-hole 101 is hardly spilled upward from below by the pressure.

Nevertheless, it is safe design to adjust the mass and the angle θ′ of the oil 203 in the liquid supply pipe 350 such that the pressure applied to the oil 203 present on the lower side of the array chip 100 does not exceed the bursting pressure P_{B}.

### Modified Example of First Embodiment

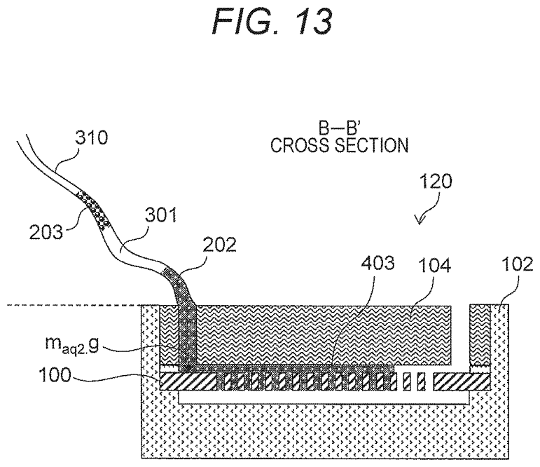

FIG. 13 is a diagram illustrating a modified example of the liquid supply pipe. As illustrated in FIG. 13, the liquid supply pipe 310 is not straight, and the thickness varies depending on the location. Even in such a case, it is possible to supply the liquid only by gravity as described above and to favorably fill the through-holes 101 with the solution 202 to be inspected. In this case, first, the inner diameter of the thickest portion of the liquid supply pipe 310 may be smaller than 2.5 mm (particularly, 1.5 mm or less). In a case where the cross-section of the liquid supply pipe 310 is not circular, the cross-sectional area of the hollow portion of the liquid supply pipe 310 may be smaller than 2.5×2.5×n/4 mm², and particularly 1.5×1.5×n/4 mm² or less. Accordingly, the liquid is supplied while the layer of the air 301 between the oil 203 and the solution 202 to be inspected is maintained. In addition, it is sufficient that the pressure applied to the solution (portion 403) to be inspected positioned on the upper surface of the array chip 100 at the time of the liquid supply does not exceed the bursting pressure P_{B} from beginning to end. If so, the solution to be inspected can be supplied without leaking out to the lower side and the left and right of the through-holes. Since the liquid supply pipe 310 is not straight and the thickness varies depending on the location, the pressure applied to the portion 403 cannot be written in a simplified formula as in the first embodiment. However, it is possible to calculate the pressure applied to the portion 403 by dividing the liquid supply pipe 310 into minute regions, calculating the force acting in the parallel direction of the liquid supply pipe 310 in the gravity force applied to the solution 202 to be inspected or the gravity force applied to the oil 203 in each portion, and integrating them. The mass of the solution to be inspected, the mass of the oil, the degree of bending of the liquid supply pipe 310, and the angle of the liquid supply pipe 310 may be adjusted so that the pressure calculated in this manner does not exceed the bursting pressure P_{B}.

### Conclusion of First Embodiment

As described above, the liquid supply method of the first embodiment is a liquid supply method for supplying the solution 202 to be inspected to the through-holes 101 (spots) formed in an array in the array chip 100 (substrate), and includes preparing the liquid supply pipe 300 in which the solution 202 to be inspected, the air 301, and the oil 203 are disposed in this order, and installing the liquid supply pipe 300 above the array chip 100 at the angle θ at which the solution 202 to be inspected is positioned at the lowest position and the solution 202 to be inspected, the air 301, and the oil 203 flow onto the front surface of the array chip 100 by gravity. The cross-sectional area of the liquid supply pipe 300 is designed such that the air 301 continues to be present between the solution 202 to be inspected and the oil 203 while the solution 202 to be inspected, the air 301, and the oil 203 are flowing through the liquid supply pipe 300. After the solution 202 to be inspected is supplied to the through-holes 101, the solution 202 to be inspected present on the front surface of the array chip 100 is replaced with the air 301, and then the liquid supply advances such that the oil 203 covers the front surface of the array chip 100.

According to the liquid supply method of the present embodiment, a driving force required for the liquid supply is gravity and does not require electric power. Since the loader is not used, the filling rate of the solution 202 to be inspected into each through-hole 101 does not change or there are no through-holes 101 partially that are not filled due to the variation in the angle or the position at which the loader comes into contact with the front surface of the array chip 100. That is, the filling rate of the solution 202 to be inspected into the through-holes 101 becomes uniform. Accordingly, the solution 202 to be inspected can be filled in the through-holes 101 with a good yield.

Since the array chip 100 is housed in the flow cell 120, the upper side of the array chip 100 is not largely opened to the atmosphere, including during and before and after the liquid supply. Accordingly, there is a low risk that the foreign matters (particles), the DNA, and the like floating in the atmosphere are mixed into the through-hole array 110 during and before and after liquid supply.

### Second Embodiment

In a second embodiment, a method for supplying a solution to the array chip 100 including a step of filling the liquid supply pipe 300 with the solution 202 to be inspected, the air 301, and the oil 203 will be described.

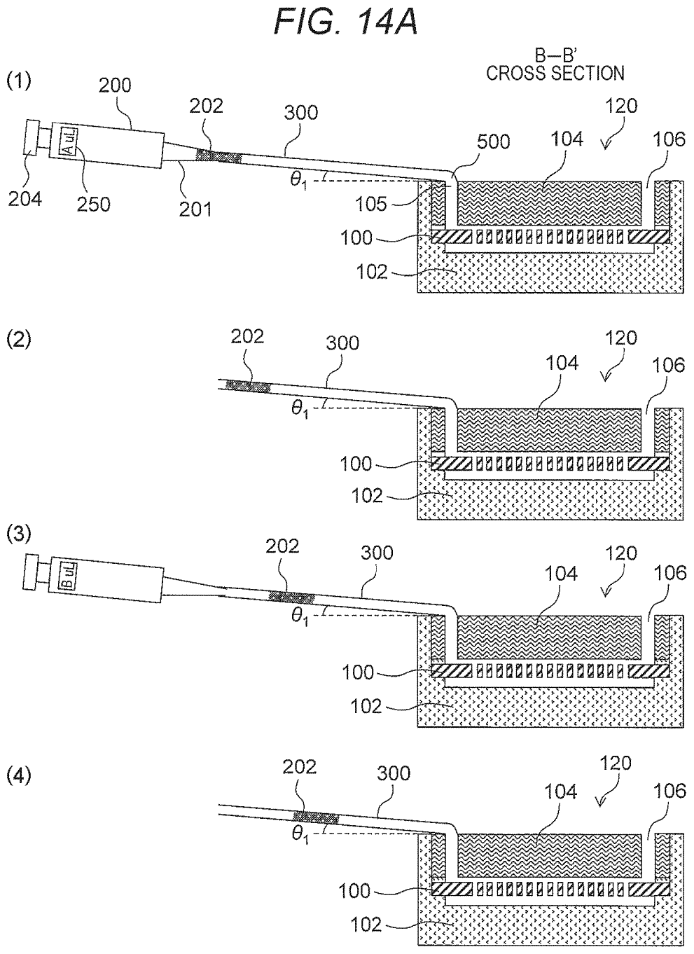

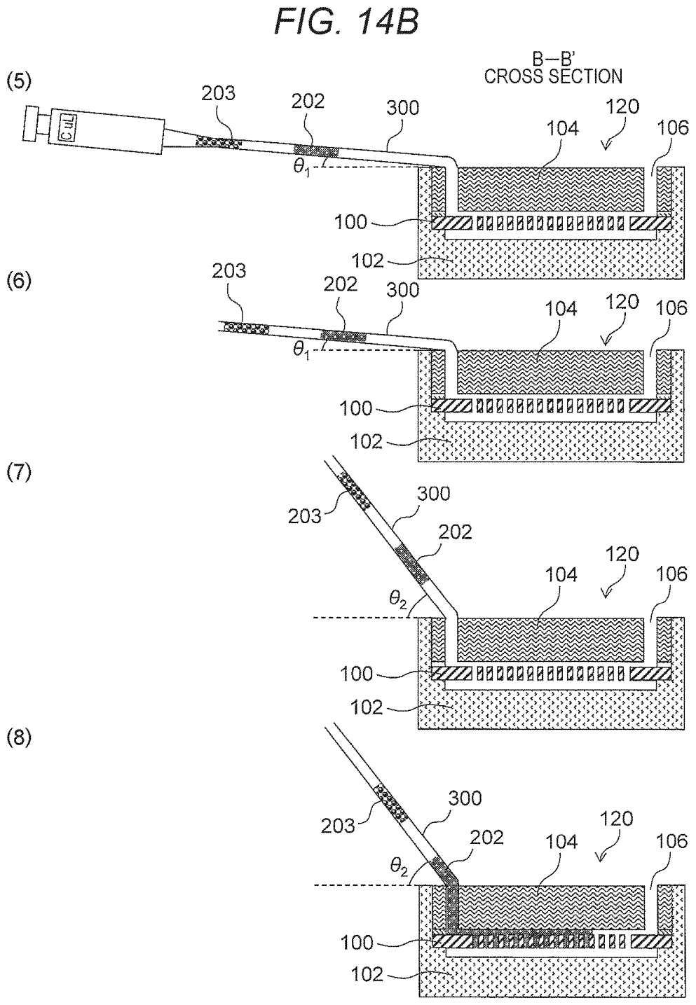

FIGS. 14A and 14B are diagrams illustrating a liquid supply method to the array chip 100 according to the second embodiment. First, the operator aspirates the solution 202 to be inspected from a container (not illustrated) containing the solution 202 to be inspected to the distal end portion 201 of the pipette 200. Thereafter, in step (1) of FIG. 14A, the operator connects the pipette 200 to the liquid supply pipe 300, and manually pressing the push button 204 to fill the liquid supply pipe 300 with the solution 202 to be inspected. A connecting portion 500 between the liquid supply pipe 300 and the introduction port 105 is movable, and the angle θ of the liquid supply pipe 300 with respect to the flow cell 120 (the angle of the liquid supply pipe 300 with respect to the horizontal plane) can be adjusted. The amount of the solution 202 to be inspected to be filled in the liquid supply pipe 300 is set to A μL. A liquid amount adjustment scale 250 of the pipette 200 may be set to A μL in advance.

In step (2) of FIG. 14A, the operator fills the liquid supply pipe 300 with the solution 202 to be inspected, and then removes the pipette 200 from the liquid supply pipe 300. In this state, the solution 202 to be inspected is stopped in the liquid supply pipe 300.

In step (3) of FIG. 14A, the operator connects the distal end portion 201 of the pipette 200 to the liquid supply pipe 300 again, and manually presses the push button 204 to send air. The amount of air to be injected is B μL. The liquid amount adjustment scale 250 of the pipette 200 may be set to B μL in advance.

In step (4) of FIG. 14A, the operator removes the pipette 200 from the liquid supply pipe 300.

Thereafter, the operator aspirates the oil 203 from a container (not illustrated) containing the oil 203 to the distal end portion 201 of the pipette 200. In step (5) of FIG. 14B, the operator connects the distal end portion 201 of the pipette 200 to the liquid supply pipe 300 again, and manually presses the push button 204 to send the oil 203. The amount of air to be injected is set to C μL. The liquid amount adjustment scale 250 of the pipette 200 may be set to C μL in advance.

In step (6) of FIG. 14B, the operator removes the pipette 200 from the liquid supply pipe 300.

In step (7) of FIG. 14B, the operator increases the angle of the liquid supply pipe 300 from θ₁ to θ₂. By holding the liquid supply pipe in this state, in step (8) of FIG. 14B, the solution 202 to be inspected flows out to the front surface of the array chip 100 in the flow cell 120 and is filled in the through-holes in the array chip 100. Thereafter, the excess solution 202 to be inspected on the front surface of the array chip 100 is replaced with the air, and then the air on the front surface of the array chip 100 is replaced with the oil 203. The mass of the solution 202 to be inspected and the mass of the oil 203 are adjusted such that the pressure applied to the solution to be inspected on the front surface of the array chip 100 does not exceed the bursting pressure P_{B} in liquid supply in a state where the angle of the liquid supply pipe is θ₂.

In the present embodiment, when the liquid supply pipe 300 is filled with the solution 202 to be inspected, the air, and the oil 203, the angle θ of the liquid supply pipe 300 is θ₁. The angle θ₁ is an angle at which the solution 202 to be inspected and the oil 203 do not spontaneously advance toward the flow cell 120 and the array chip 100 after the solution 202 to be inspected and the oil 203 are loaded in the liquid supply pipe 300 and the pipette 200 is removed. That is, at the angle θ₁, the frictional force generated between the solution 202 to be inspected and the oil 203 and the liquid supply pipe 300 is balanced with the force derived from gravity applied to the solution 202 to be inspected and the gravity applied to the oil 203, and the solution 202 to be inspected and the oil 203 cannot flow in the liquid supply pipe 300 and are stopped. On the other hand, when the solution 202 to be inspected, the air, and the oil 203 are supplied from the liquid supply pipe 300 to the flow cell 120 and the array chip 100, the angle θ of the liquid supply pipe 300 is θ₂. At this angle θ₂, since the force derived from gravity applied to the solution 202 to be inspected and the gravity applied to the oil 203 is larger than the frictional force generated between the solution 202 to be inspected and the oil 203 and the liquid supply pipe 300, the solution 202 to be inspected and the oil 203 can flow in the liquid supply pipe 300.

A range of the angle θ₁ at which the solution 202 to be inspected and the oil 203 are stopped in the liquid supply pipe 300 and a range of the angle θ₂ at which the solution 202 to be inspected and the oil 203 can flow in the liquid supply pipe 300 change depending on the material or the inner diameter of the liquid supply pipe 300, the composition of the solution 202 to be inspected, and the type of the oil 203. However, it is needless to say that the ranges of the angles θ₁ and θ₂ can be easily obtained experimentally by using the liquid supply pipe 300 to be used, the solution 202 to be inspected, and the oil 203.

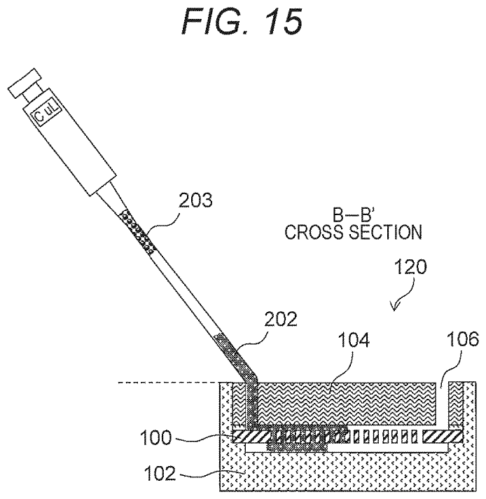

FIG. 15 is a diagram for describing a contact timing between the solution 202 to be inspected and the array chip 100. As described above, it is important that the solution 202 to be inspected does not come into contact with the array chip 100 until the solution 202 to be inspected, the air, and the oil 203 are completely filled in the liquid supply pipe 300. The reason will be described below. In a case where the oil 203 is supplied to the liquid supply pipe 300 after the solution 202 to be inspected reaches the front surface of the array chip 100, and when the extrusion force is too strong or the extrusion speed is too fast due to the variation in the extrusion force or the extrusion speed when the oil 203 is supplied to the liquid supply pipe 300, the pressure applied to the solution 202 to be inspected exceeds the bursting pressure P_{B}. As a result, as illustrated in FIG. 15, the solution 202 to be inspected may leak out to the back surface of the array chip 100 through the through-holes 101. By doing this, the solutions to be inspected inside different through-holes 101 are connected to each other, and the inspection accuracy of the dPCR decreases. Accordingly, it is important that the solution 202 to be inspected does not come into contact with the array chip 100 until the liquid supply pipe 300 is completely filled with the solution 202 to be inspected, the air, and the oil 203.

### Modified Example of Second Embodiment

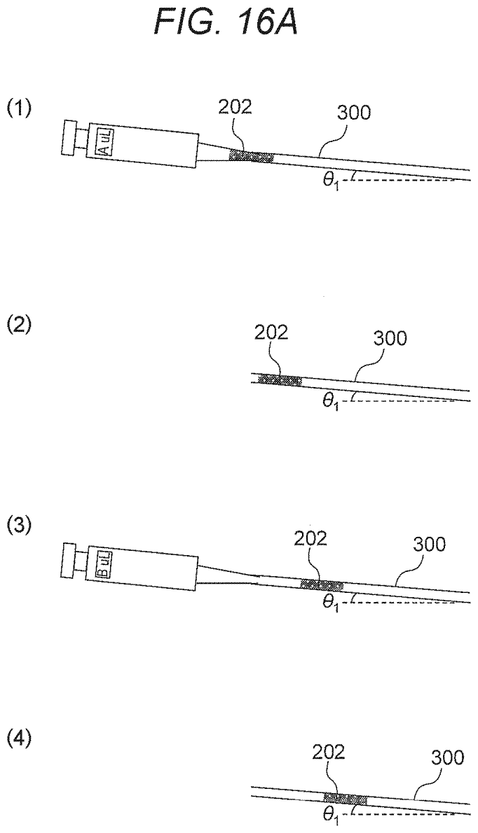

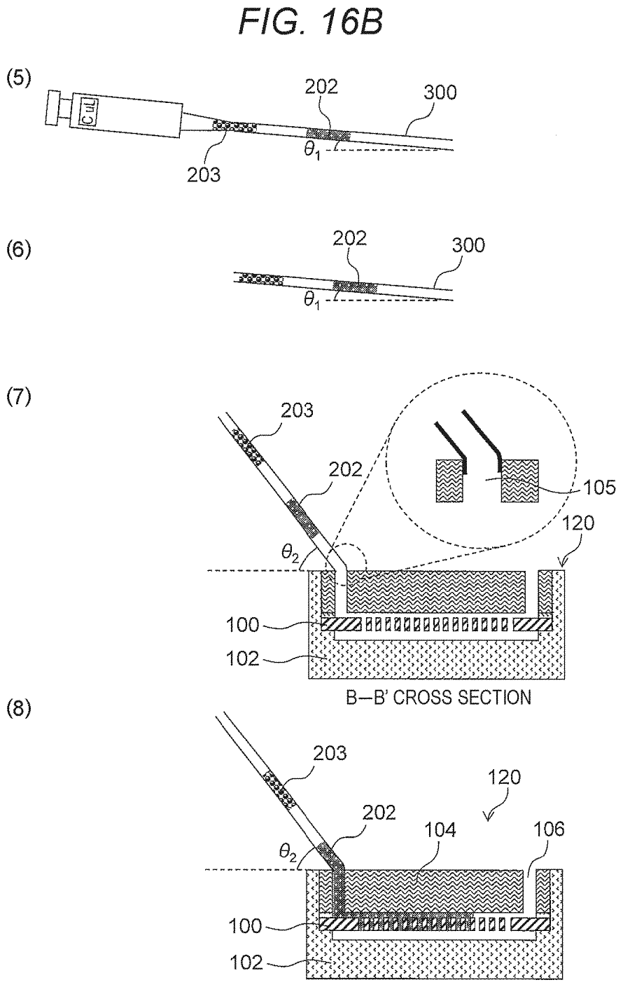

FIGS. 16A and 16B are diagrams illustrating a liquid supply method to the array chip 100 according to a modified example of the second embodiment. In a method adopted in the present modified example, the solution 202 to be inspected, the air, and the oil 203 are filled into the liquid supply pipe 300 in a state where the liquid supply pipe 300 is removed from the flow cell 120, and then it is attached to the flow cell 120 to supply the liquid. The other points are performed as described in the second embodiment. Steps (1) to (6) illustrated in FIGS. 16A and 16B are different from steps (1) to (6) illustrated in FIGS. 14A and 14B only in that the liquid supply pipe 300 is not connected to the flow cell 120. In step (7) of FIG. 16B, the operator connects the liquid supply pipe 300 to the flow cell 120. The distal end portion of the liquid supply pipe 300 is formed of a flexible material, and can be tightly inserted into the introduction port 105. Thereafter, step (8) is the same as the step in the second embodiment.

### Conclusion of Second Embodiment

As described above, the liquid supply method of the second embodiment includes filling the liquid supply pipe 300 with the solution 202 to be inspected, the air 301, and the oil 203 in a state where the angle of the liquid supply pipe 300 with respect to the array chip 100 is θ₁ (first angle), and supplying the liquid in a state where the angle of the liquid supply pipe 300 is θ₂ (second angle) larger than θ₁ after completion of the filling. The other points are the same as the points of the first embodiment. The angle θ₁ is an angle at which the solution 202 to be inspected is stopped in the liquid supply pipe 300 at a stage where only the solution 202 to be inspected is filled in the liquid supply pipe 300. As described above, similarly to the first embodiment, in the second embodiment, the driving force required for supplying the liquid is also gravity, and electric power is also not required. It is possible to fill the through-holes 101 with the solution 202 to be inspected with a good yield.

### Third Embodiment

In the second embodiment, it has been described that an inclination angle of the liquid supply pipe 300 is changed between when the liquid supply pipe 300 is filled with the solution 202, the air, and the oil 203 and when the solution 202 is supplied to the flow cell 120. Therefore, in a third embodiment, a technology for executing the method described in the second embodiment without changing the inclination angle of the liquid supply pipe 300 is proposed.

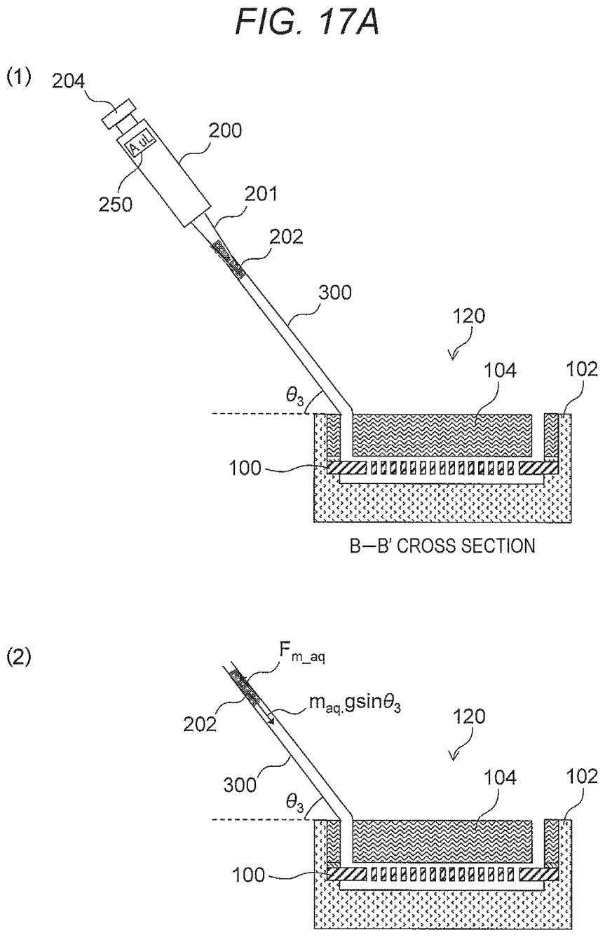

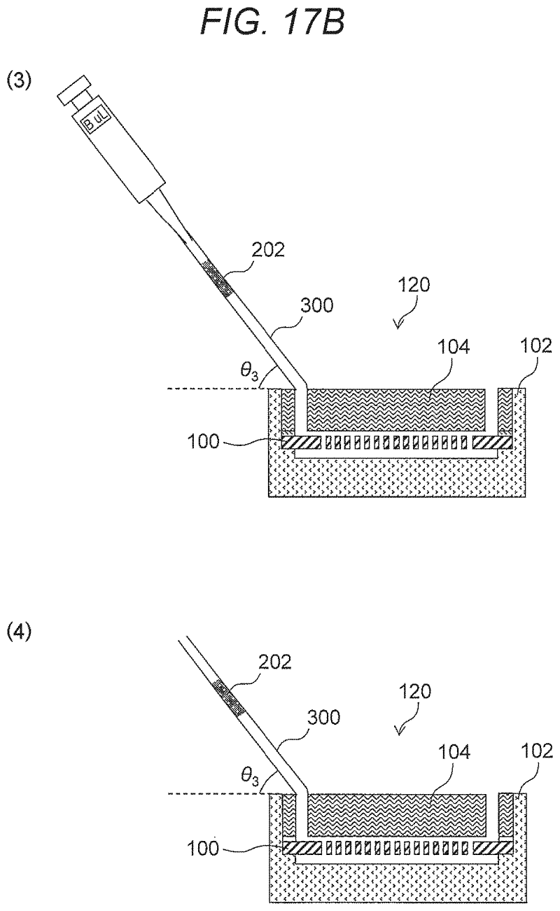

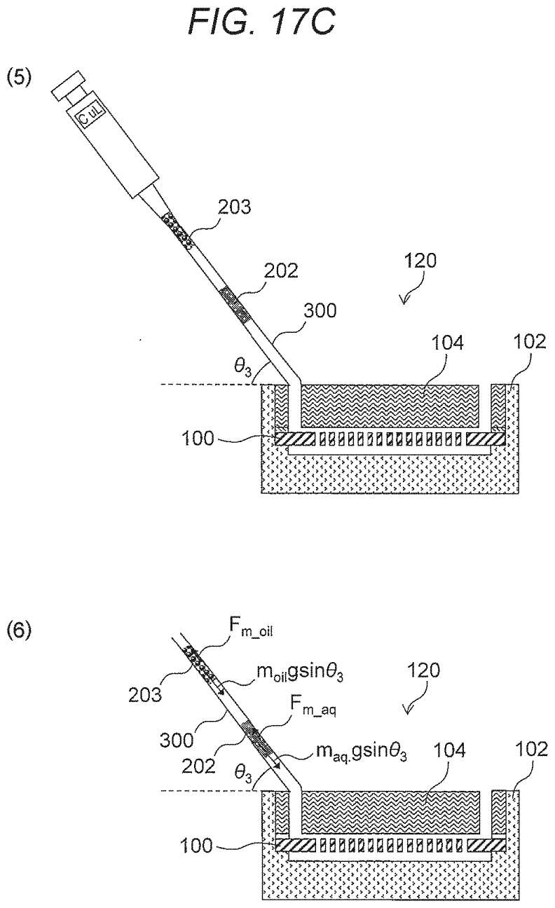

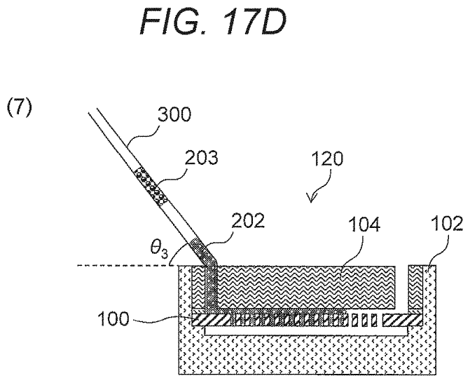

FIGS. 17A to 17D are diagrams illustrating a liquid supply method to the array chip 100 according to the third embodiment. Since the overall flow of the liquid supply method of the present embodiment is similar to the flow of the second embodiment, differences will be mainly described below.

As illustrated in FIGS. 17A to 17D, in the present embodiment, the angle of the liquid supply pipe 300 is constantly θ₃. The angle θ₃ is an angle at which the solution 202 to be inspected does not spontaneously advance toward the flow cell 120 and the array chip 100 after only the solution 202 to be inspected is loaded in the liquid supply pipe 300 and the pipette 200 is removed. That is, at the angle θ₃, the frictional force generated between the solution 202 to be inspected and the liquid supply pipe 300 is balanced with the gravity-derived force applied to the solution 202 to be inspected, and the solution 202 to be inspected is stopped without being able to flow in the liquid supply pipe 300. On the other hand, the angle θ₃ is an angle at which the oil 203 spontaneously advances toward the flow cell 120 and the array chip 100 after only the oil 203 is loaded in the liquid supply pipe 300 and the pipette 200 is removed. That is, at the angle θ₃, the gravity-derived force applied to the oil 203 is larger than the frictional force generated between the oil 203 and the liquid supply pipe 300, and the oil 203 can flow to the flow cell 120 and the array chip 100 in the liquid supply pipe 300. The angle θ₃ is an angle at which the oil 203 and the solution 202 to be inspected spontaneously advance toward the flow cell 120 and the array chip 100 in a case where the solution 202 to be inspected is injected into the liquid supply pipe 300 and then the oil 203 is supplied onto the solution to be inspected (to a position higher than a position of the solution 202 to be inspected in the liquid supply pipe 300 from the ground). That is, at the angle θ₃, the solution 202 to be inspected can flow to the flow cell 120 and the array chip 100 by the gravity-derived force applied to the oil 203. Whether or not such an angle θ₃ exists depends on the material and the inner diameter of the liquid supply pipe 300, the composition of the solution 202 to be inspected, and the type of the oil 203. In a case where such an angle θ₃ exists, the range of the angle θ₃ changes depending on the material or the inner diameter of the liquid supply pipe, the composition of the solution 202 to be inspected, and the type of the oil 203. However, it is needless to say that whether the angle θ₃ exists and the range of the angle θ₃ in a case where the angle θ₃ exists can be easily obtained experimentally by using the liquid supply pipe 300 to be used, the solution 202 to be inspected, and the oil 203.

In FIG. 17A(1), the operator fills the liquid supply pipe with the solution 202 to be inspected, and then removes the pipette 200 from the liquid supply pipe 300. Thus, a state illustrated in FIG. 17A(2) is obtained. At this time, as described above, a gravity-derived force m_{aq}.g sin θ₃ applied to the solution 202 to be inspected and a frictional force F_{m_aq} acting between the solution 202 to be inspected and the inner wall of the liquid supply pipe 300 are balanced. Accordingly, the solution 202 to be inspected is stopped without flowing down toward the flow cell 120 and the array chip 100.

In FIG. 17B(3), the air is supplied to the liquid supply pipe 300 and the pipette 200 is removed from the liquid supply pipe 300. Thus, a state illustrated in FIG. 17B(4) is obtained. At this time, as described above, the gravity-derived force m_{aq}.g sin θ applied to the solution 202 to be inspected and the frictional force F_{m_aq} acting between the solution 202 to be inspected and the inner wall of the liquid supply pipe 300 are balanced. Accordingly, the solution 202 to be inspected is stopped without flowing down toward the flow cell and the array chip 100.

Thereafter, in FIG. 17C(5), the distal end portion 201 of the pipette 200 is connected to the liquid supply pipe again, and the oil 203 is supplied. Thereafter, the pipette 200 is removed from the liquid supply pipe 300, and thus, a state as illustrated in FIG. 17C(6) is obtained. At this time, as described above, since mₒᵢₗg sin θ₃>F_{m_oil} (F_{m_oil} is a frictional force acting between the oil and the inner wall of the liquid supply pipe) and mₒᵢₗg sin θ₃−F_{m_oil}+m_{aq}.g sin θ₃−F_{m_aq}>0, the solution 202 to be inspected, the air, and the oil 203 flow out toward the flow cell 120 and the array chip 100, and a state as illustrated in FIG. 17D(7) is obtained. In the liquid supply of the present embodiment, the mass of the solution 202 to be inspected and the mass of the oil 203 are also adjusted such that the pressure applied to the solution 202 to be inspected on the front surface of the array chip 100 does not exceed the bursting pressure P_{B}.

### Conclusion of Third Embodiment

According to the present embodiment, since the solution 202 can be fractionated into the through-holes 101 without changing the inclination angle of the liquid supply pipe 300, it can be said that the method is a simpler liquid supply method.

### Fourth Embodiment

In the second and third embodiments, it has been described that the angle of the liquid supply pipe 300 during the liquid supply to the flow cell 120 is constant at the angle θ₂ (second embodiment) or the angle θ₃ (third embodiment). Therefore, in a fourth embodiment, a method for changing the angle of the liquid supply pipe 300 during the liquid supply to the flow cell 120 is proposed.

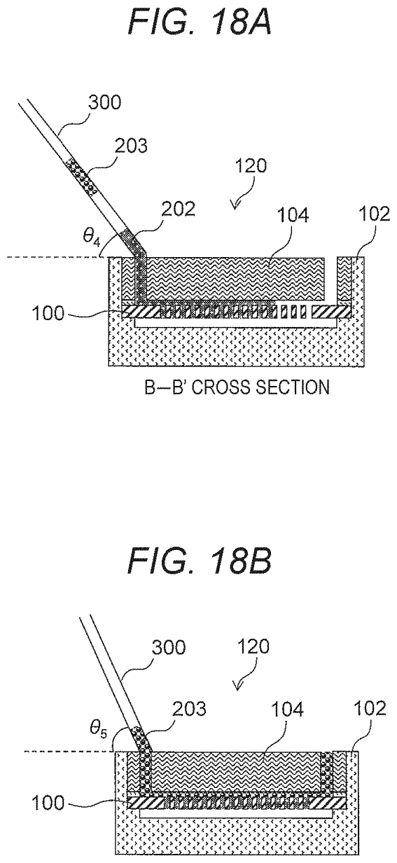

FIGS. 18A and 18B are diagrams illustrating a liquid supply method to the array chip 100 according to the fourth embodiment. As illustrated in FIG. 18A, in an initial stage when liquid supply is started, the angle of the liquid supply pipe 300 is θ₄. As illustrated in FIG. 18B, when the liquid supply is about to end, the angle of the liquid supply pipe 300 is adjusted to be an angle θ₅ (θ₅>θ₄). The angle of the liquid supply pipe 300 may gradually change during the liquid supply, or may change only once. In a case where the angle of the liquid supply pipe 300 is constant, the supply speeds of the solution 202 to be inspected and the oil 203 to the array chip 100 decrease as the amounts of the solution 202 to be inspected and the oil 203 in the liquid supply pipe 300 decrease. However, the inclination angle of the liquid supply pipe 300 is increased as the liquid supply progresses, thereby the force acting in a parallel direction of the liquid supply pipe 300 within the gravity applied to the solution 202 to be inspected and the oil 203 in the liquid supply pipe 300 can be increased. As a result, it is possible to supply the solution 202 to be inspected and the oil 203 without reducing the supply speed. Accordingly, the inspection efficiency of the dPCR increases. In the present embodiment, the mass of the solution 202 to be inspected and the mass of the oil 203 are also adjusted such that the pressure applied to the solution 202 to be inspected on the front surface of the array chip 100 does not exceed the bursting pressure P_{B}.

### Conclusion of Fourth Embodiment

According to the present embodiment, since the inclination angle of the liquid supply pipe 300 is increased during the liquid supply to the array chip 100, it is possible to suppress a decrease in the liquid supply speed, and it is possible to efficiently supply the liquid.

### Fifth Embodiment

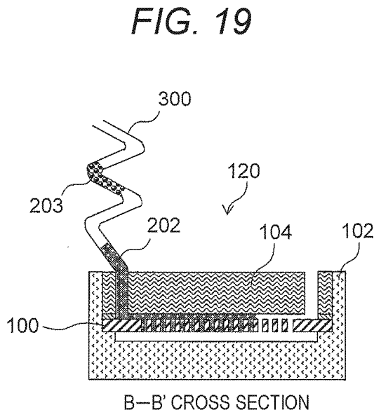

FIG. 19 is a diagram illustrating a structure of a liquid supply pipe according to a fifth embodiment. As illustrated in FIG. 19, since the liquid supply pipe 300 has a zigzag structure or a spiral structure, it is possible to save a space occupied by the liquid supply pipe 300.

### Sixth Embodiment

In the first to fifth embodiments, the technology of supplying the liquid by using a liquid supply pipe having a tubular shape from one end to the other end has been described. In a sixth embodiment, a liquid supply method using a liquid supply pipe having another shape is proposed.

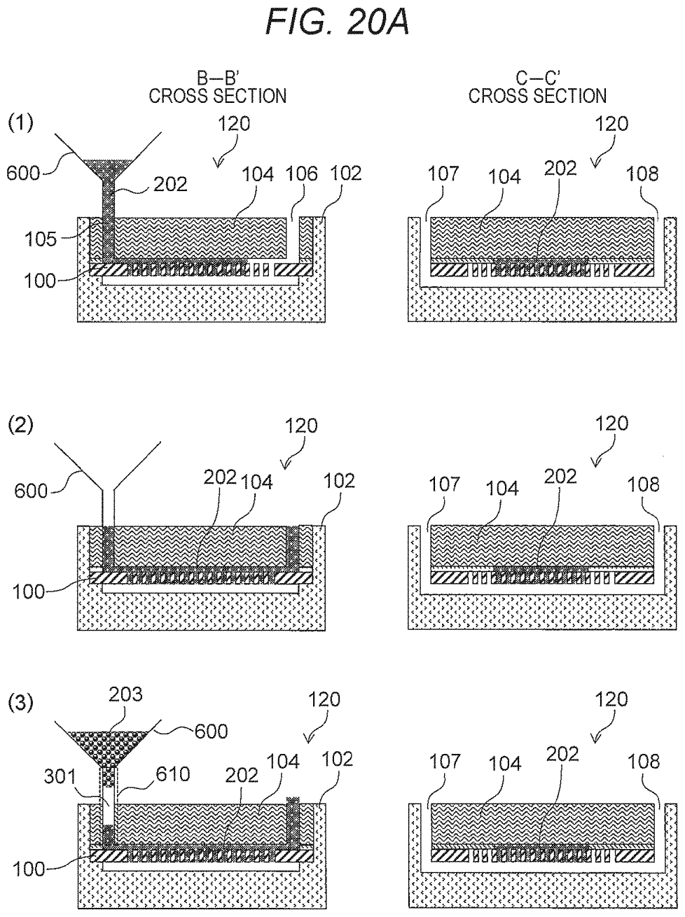

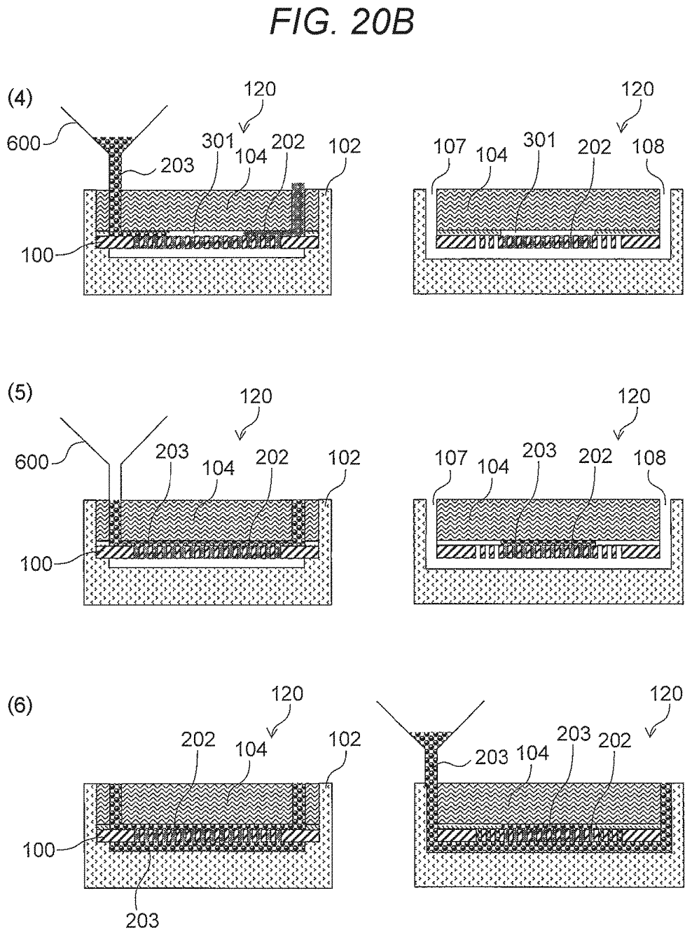

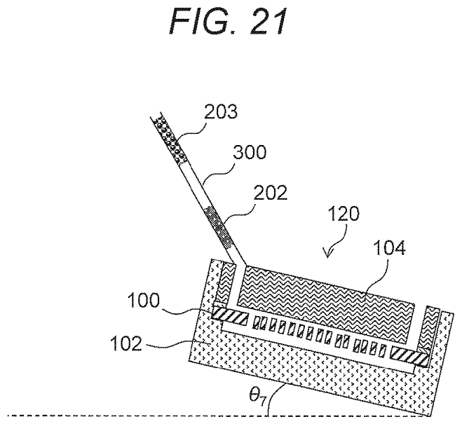

FIGS. 20A and 20B are diagrams illustrating a liquid supply method to the array chip 100 according to the sixth embodiment. In the present embodiment, a liquid supply pipe 600 having a funnel shape at one end and a tubular shape at the other end is used. The liquid supply pipe 600 is attached to the introduction port 105. First, as illustrated in FIG. 20A(1), the operator supplies the solution 202 to be inspected to a funnel-shaped portion of the liquid supply pipe 600. Accordingly, the solution 202 to be inspected fills the front surface of the array chip 100 and the through-holes 101. The solution 202 to be inspected overflowing from the discharge port 106 is discarded.

As illustrated in FIG. 20A(2), when the supply of the solution 202 to be inspected is completed, a height of a liquid level of the introduction port 105 and a height of a liquid level of the discharge port 106 become the same.

Subsequently, as illustrated in FIG. 20A(3), the operator supplies the oil 203 to the funnel-shaped portion of the liquid supply pipe 600. At this time, in a case where an inner diameter or a cross-sectional area of a portion 610 surrounded by a broken line in a flow path between the liquid supply pipe 600 and the flow cell is sufficiently small (in a case where the inner diameter is smaller than 2.5 mm or the cross-sectional area is smaller than 2.5×2.5×π/4 mm²), the oil 203 and the solution 202 to be inspected are supplied while the layer of the air 301 is maintained between the oil 203 and the solution 202 to be inspected. Accordingly, the liquid is supplied as illustrated in FIG. 20B(4). The solution 202 and the oil 203 overflowing from the discharge port 106 are discarded. When the filling of the front surface of the array chip 100 with the oil 203 is completed, a state illustrated in FIG. 20B(5) is obtained.

Thereafter, as illustrated in FIG. 20B(6), the operator connects the liquid supply pipe 600 to the introduction port 107 and supplies the oil 203 to the funnel-shaped portion to fill the back surface of the array chip 100 with the oil 203.

In the present embodiment, the mass of the solution 202 to be inspected and the mass of the oil 203 supplied to the funnel-shaped portion of the liquid supply pipe 600 are also adjusted so that the pressure applied to the solution 202 to be inspected on the front surface of the array chip 100 does not exceed the bursting pressure P_{B}.

### Conclusion of Sixth Embodiment

According to the present embodiment, since one end portion of the liquid supply pipe 600 has the funnel shape, the solution 202 and the oil 203 can be easily supplied into the liquid supply pipe 600 as compared with a case where the one end portion has a tubular shape. In particular, it is not necessary to aspirate the solution 202 into the pipette from the container containing the solution 202 or to aspirate the oil 203 into the pipette from the container containing the oil 203, and the solution 202 and the oil 203 may be merely poured into the funnel-shaped portion directly from these containers.

### Seventh Embodiment

In the first to sixth embodiments, it has been described that the liquid supply pipe is inclined with respect to the horizontal plane (flow cell). On the other hand, in a seventh embodiment, the flow cell is inclined with respect to the horizontal plane and the liquid is supplied.

FIG. 21 is a diagram illustrating a liquid supply method to the array chip 100 according to the seventh embodiment. As illustrated in FIG. 21, the flow cell is inclined with respect to the horizontal plane by an angle θ₇. The flow cell is inclined in this manner, and thus, the speed at which the solution 202 to be inspected and the oil 203 are supplied into the flow cell can be increased. Accordingly, the inspection efficiency of the dPCR increases.

### Eighth Embodiment

In an eighth embodiment, a method of PCR reaction and fluorescence observation after the solution to be inspected and the oil are supplied to the flow cell will be described.

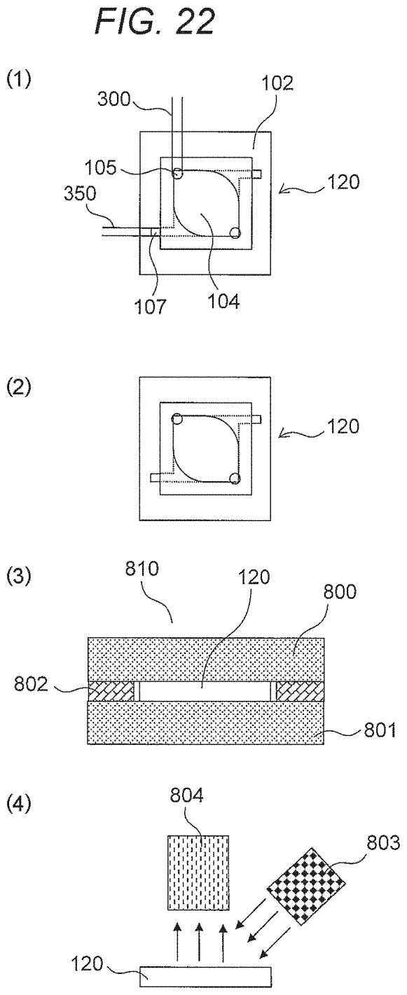

FIG. 22 is a diagram for describing the method of PCR reaction and fluorescence observation according to the eighth embodiment. As illustrated in FIG. 22(1), the liquid supply pipes 300 and 350 are connected to the flow cell after the solution to be inspected and oil are supplied. Subsequently, as illustrated in FIG. 22(2), the operator removes the liquid supply pipes 300 and 350 from the flow cell 120. Thereafter, as illustrated in FIG. 22(3), the operator installs the flow cell 120 in a thermal cycler 810. The thermal cycler 810 includes an upper lid 800, a lower pedestal 801, and a spacer 802. Temperatures of the upper lid 800 and the lower pedestal 801 can be controlled. The temperatures of the upper lid 800 and the lower pedestal 801 are controlled such that, for example, two temperatures of 60° C. and 98° C. are repeated, the PCR reaction can be caused. After the PCR reaction is completed, as illustrated in FIG. 22(4), the operator performs the fluorescence observation of the array chip 100. Specifically, excitation light is emitted from a light source 803 toward the flow cell 120, and the through-hole array is observed with a CMOS camera 804.

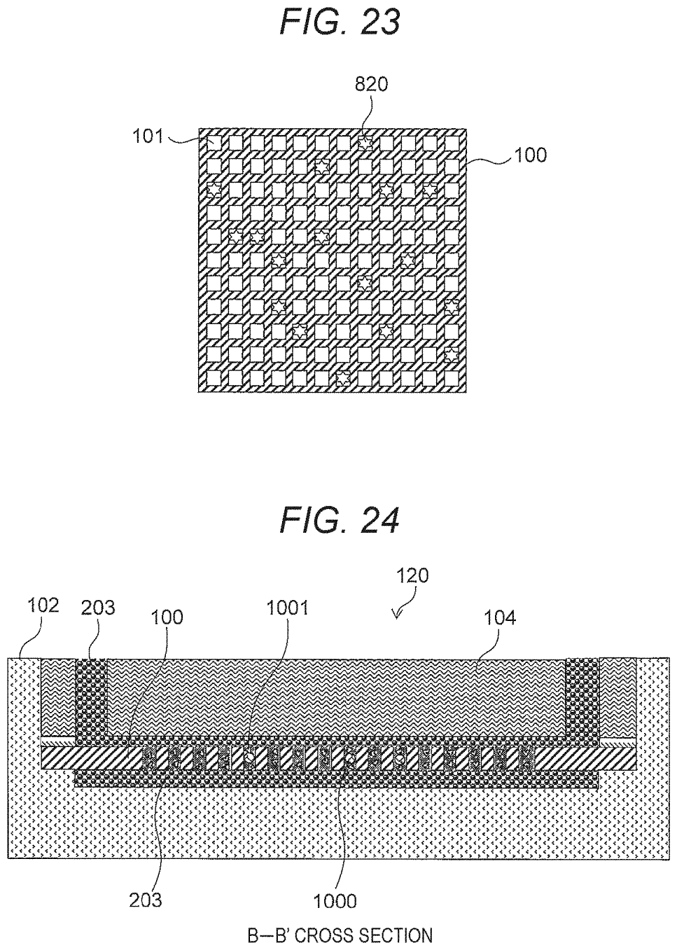

FIG. 23 is a schematic diagram illustrating an example of a result of the fluorescence observation of the flow cell 120. As illustrated in FIG. 23, fluorescence 820 is observed from the through-holes 101 in which there are the DNA sequences to be detected.

### Ninth Embodiment

In the first to eighth embodiments, a target to be detected is DNA. However, the technology of the present disclosure is also useful other than detecting the DNA by the dPCR. As an example, in a ninth embodiment, a method for inspecting whether there is an influenza virus in the solution to be inspected will be described.

As a premise knowledge, it is first described that influenza has an enzyme in a protruding shape like a mushroom called neuraminidase on a front surface thereof and there is a fluorogenic substrate (for example, 2′-(4-Methylumbelliferyl)-α-D-N-acetylneuraminic acid (MUNANA)) that emits fluorescence when the fluorogenic substrate is decomposed by the neuraminidase of the influenza virus.

A procedure of the present embodiment will be described below. First, the operator mixes the fluorogenic substrate that emits fluorescence when the fluorogenic substrate is decomposed by the neuraminidase of the influenza virus in the solution 202 to be inspected. The other points are the same as the liquid supply procedure described in the first embodiment, and thus, the description thereof is omitted.

FIG. 24 is a diagram illustrating the flow cell 120 in which the array chip 100 is incorporated after the liquid supply method according to the ninth embodiment is performed. As illustrated in FIG. 24, there are through-holes 101 in which there are the influenza viruses 1000 and through-holes 101 in which there is no influenza virus 1000. There is a fluorogenic substrate 1001 in each through-hole 101. Since the fluorogenic substrate 1001 emits fluorescence when the fluorogenic substrate is decomposed by the neuraminidase of the influenza virus 1000, fluorescence is observed from the through-holes 101 in which there are the influenza viruses 1000 among the through-holes 101. Accordingly, when the through-hole array is observed with a camera from the upper surface and fluorescence is observed from any of the through-holes 101, it can be determined that there is the influenza virus in the solution to be inspected. If the number of through-holes is sufficiently larger than the number of influenza viruses to be inspected and the size of the through-holes is also small, only about 0 or 1 influenza virus enters each through-hole. When the through-hole array is designed in this manner, it is also possible to count the influenza virus in the solution to be inspected by counting the number of through-holes emitting fluorescence.

In the present embodiment, it has been described that influenza is detected, substances other than influenza can be detected by a similar method. In short, a component that specifically exhibits fluorescence for the presence of a substance to be detected may be introduced into the solution to be inspected. In other words, the component in the solution to be inspected may be adjusted so as to be specifically fluorescent for the presence of the substance to be detected.

### Conclusion of Ninth Embodiment

In the present embodiment, according to the liquid supply method of the present disclosure, any substance to be detected can also be detected. In the present embodiment, it is possible to favorably fractionate the solution to be inspected into the through-holes without using electric power. That is, detection accuracy of the substance to be inspected does not decrease by connecting the solutions in the adjacent through-holes.

### Tenth Embodiment

In the first to ninth embodiments, the liquid supply method to the array chip 100 having the through-hole array has been described. However, the method of the present disclosure is also useful for array chips other than the array chip 100 having the through-hole array. In a tenth embodiment, a technology of supplying a liquid to an array chip having an array of spots to which the solution to be inspected is supplied will be described.

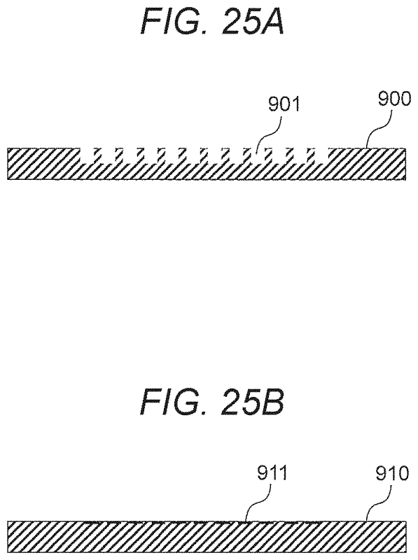

FIG. 25A is a cross-sectional view of an array chip 900 having an array of wells 901. The well 901 is a recess not penetrating the array chip 900. In such an array chip 900, a portion to be the well 901 can be formed by patterning a silicon (Si) substrate by using, for example, a lithography technology and a dry etching technology. In FIG. 25A, an inner diameter of the wells 901 is constant, but may not be constant. Although not illustrated, a shape of an upper surface of the well 901 can be a circle, an ellipse, a triangle, a quadrangle, another polygon, or the like.

FIG. 25B is a cross-sectional view of an array chip 910 having an array of hydrophilic spots 911. A portion other than the hydrophilic spot 911 of the array chip 910 is hydrophobic. A material of the array chip 910 is, for example, silicon (Si), and a material of the hydrophilic spot 911 is, for example, silicon oxide (SiO). Such an array chip 910 can form a hydrophilic spot of SiO by, for example, depositing a SiO film on a Si substrate and then patterning the SiO film into a shape of the spots 911 by using a lithography technology and a dry etching technology.

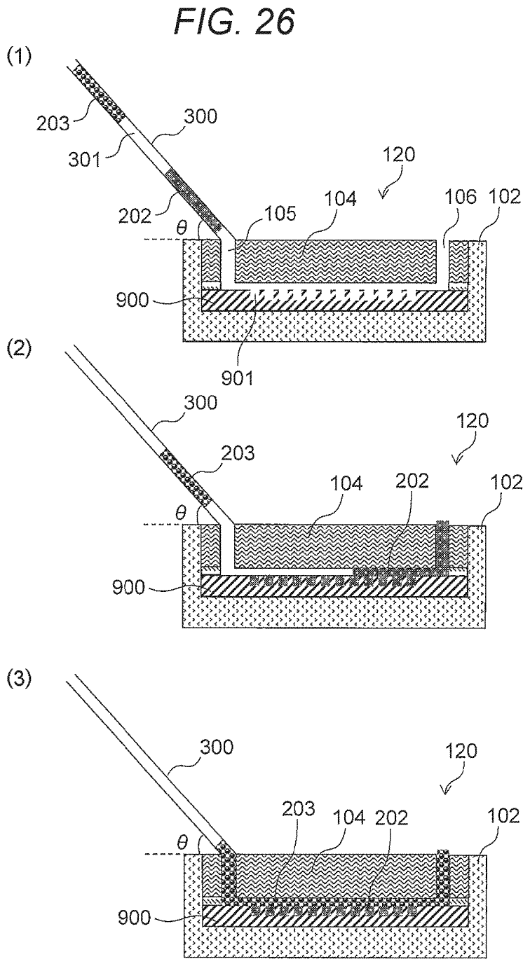

FIG. 26 is a diagram illustrating a liquid supply method to the array chip 900 according to the tenth embodiment. First, as illustrated in FIG. 26(1), the operator connects the liquid supply pipe 300 in which the solution 202 to be inspected, the air 301, and the oil 203 are disposed to the introduction port 105 of the flow cell 120. Thereafter, as illustrated in FIG. 26(2), the solution 202 to be inspected flows into the front surface of the array chip 900 and the wells 901, and subsequently, the air 301 replaces the solution 202 to be inspected on the front surface of the array chip 900. At this time, the solution 202 to be inspected present in the well 901 is not replaced. Thereafter, as illustrated in FIG. 26(3), the oil 203 flows into the front surface of the array chip 900 and covers the front surface of the array chip 900. When the layer of the air 301 passes through the front surface of the array chip 900 before the front surface of the array chip 900 is covered with the oil 203, the excess solution 202 to be inspected remaining on the front surface of the array chip 900 is evaporated and disappears from the front surface of the array chip 900. Accordingly, the solutions 202 to be inspected in the adjacent wells 901 are not connected to each other. In this manner, a spot array of the solution 202 to be inspected can be formed in the array of the wells 901.

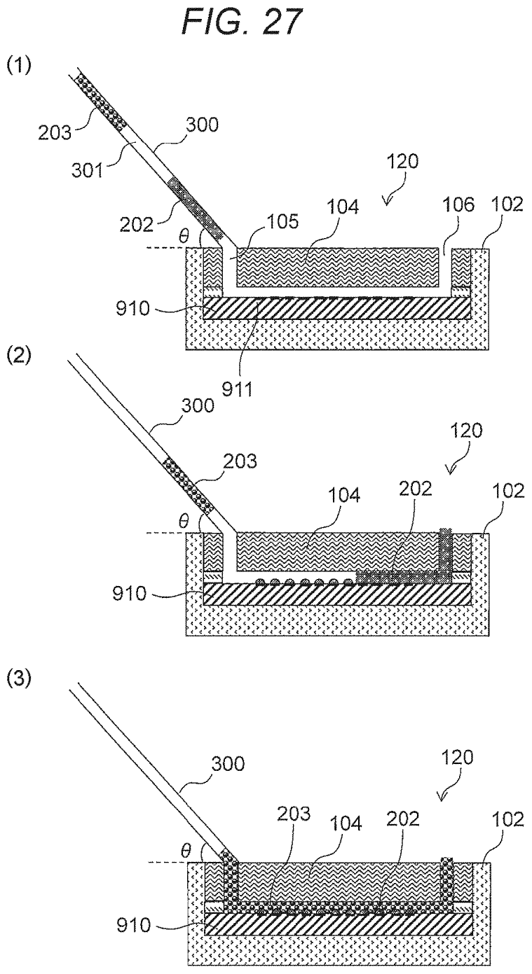

FIG. 27 is a diagram illustrating a liquid supply method to the array chip 910 according to the tenth embodiment. First, as illustrated in FIG. 27(1), the operator connects the liquid supply pipe 300 in which the solution 202 to be inspected, the air 301, and the oil 203 are disposed to the introduction port 105 of the flow cell 120. Thereafter, as illustrated in FIG. 27(2), the solution 202 to be inspected flows into the front surface of the array chip 910 and the hydrophilic spot 911, and subsequently, the air 301 replaces the solution 202 to be inspected on the front surface of the array chip. At this time, the solution 202 to be inspected present on the hydrophilic spot 911 is not replaced. Thereafter, as illustrated in FIG. 27(3), the oil 203 flows into the front surface of the array chip 910 and covers the front surface of the array chip 910 and the spot 911. When the layer of the air 301 passes through the front surface of the array chip 910 before the front surface of the array chip 910 is covered with the oil 203, the excess solution 202 to be inspected remaining on the front surface of the array chip 910 other than the hydrophilic spot 911 is evaporated and disappears from the front surface of the array chip 910. Accordingly, the solutions 202 to be inspected present in the adjacent hydrophilic spots 911 are prevented from being connected to each other. In this manner, the spot array of the solutions 202 to be inspected can be formed in the array of the hydrophilic spots 911.

### Eleventh Embodiment

In an eleventh embodiment, a liquid supply method using a flow cell having a liquid pool structure in a part of a flow path will be described.

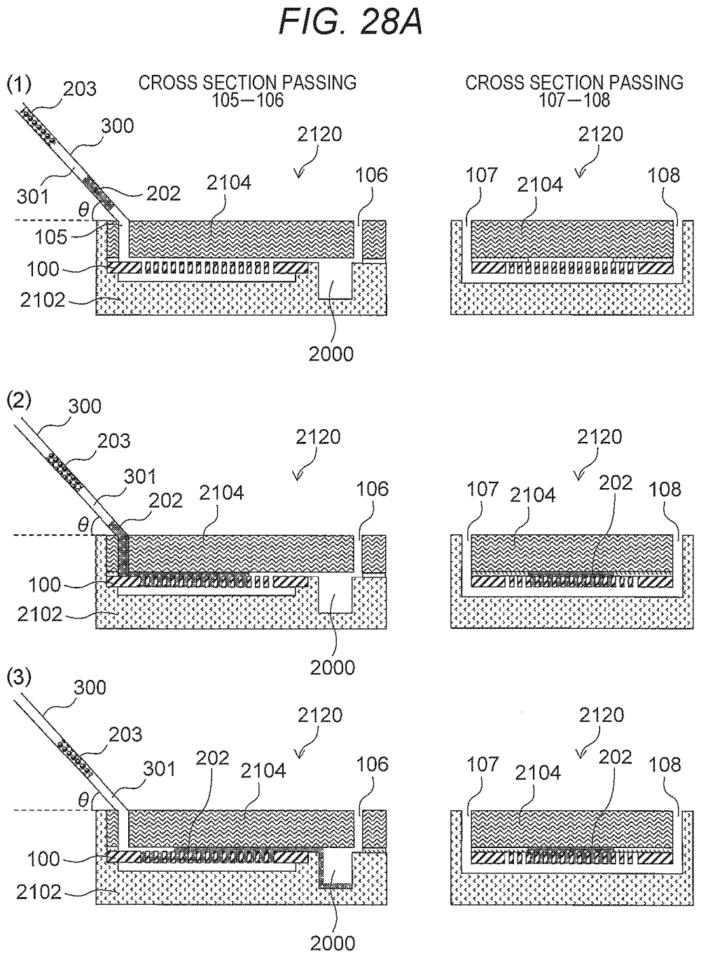

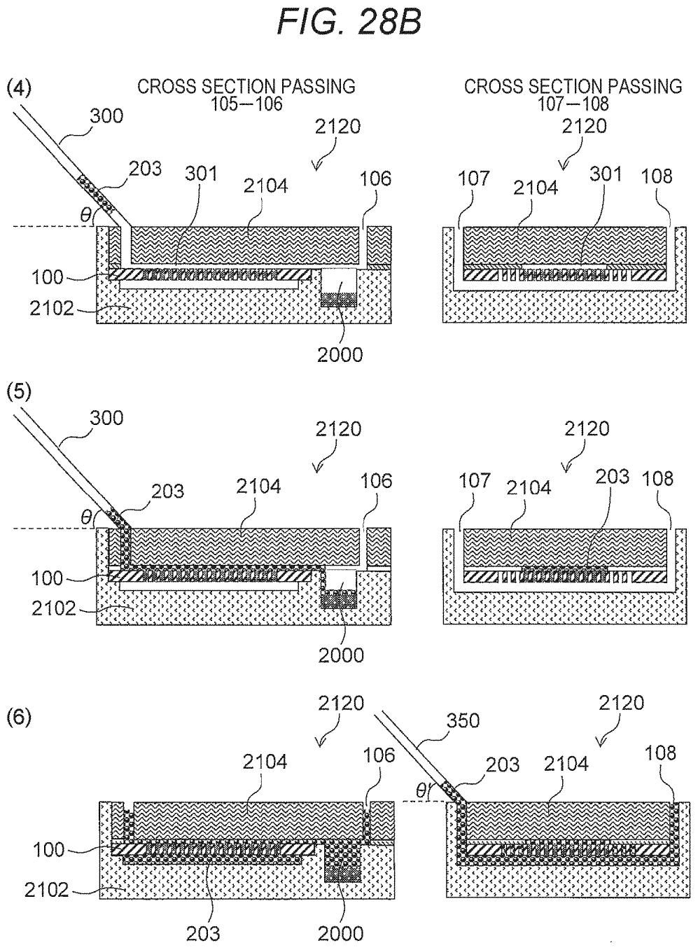

FIGS. 28A and 28B are diagrams illustrating a liquid supply method to the array chip 100 according to the eleventh embodiment. As illustrated in FIG. 28A(1), a flow cell 2120 has a lower part 2102 and an upper part 2104. The lower part 2102 has a liquid pool structure 2000 on a downstream side of the array chip 100 in the flow path. The lower part 2102 has the introduction port 107 and the discharge port 108. The upper part 2104 has the introduction port 105 and the discharge port 106.

As illustrated in FIG. 28A(1), the operator prepares the liquid supply pipe 300 filled with the solution 202 to be inspected, the air 301 separating the solution 202 to be inspected and the oil 203, and the oil 203 in advance. Next, the operator connects the liquid supply pipe 300 to the introduction port 105 such that the solution 202 to be inspected is positioned on the side (lowermost) closest to the array chip 100. An angle between the flow cell 2120 and the liquid supply pipe 300 is defined as θ. After setting to the state illustrated in step (1), almost no operation is required up to step (5) in FIG. 28B.

In step (2) of FIG. 28A, the solution 202 to be inspected is filled on the upper side of the array chip 100 and the through-holes 101 in the array chip 100 by the gravity applied to the solution 202 to be inspected and the oil 203. Thereafter, as illustrated in FIG. 28A(3), the air 301 in the liquid supply pipe 300 is extruded to the flow cell by the gravity applied to the oil 203, and the air 301 extrudes (replaces) the solution 202 to be inspected present on the upper side of the array chip 100. The extruded solution 202 to be inspected is accumulated in the liquid pool structure 2000. As illustrated in FIG. 28B(4), the solution 202 to be inspected on the upper side of the array chip 100 is completely replaced with the air 301. Thereafter, as illustrated in FIG. 28B(5), the oil 203 enters the flow cell by the gravity applied to the oil 203, and the upper side of the array chip 100 is filled with the oil. The oil also flows into the liquid pool structure 2000, and finally, as illustrated in FIG. 28B(6), the liquid pool structure is filled with the solution 202 to be inspected and the oil 203. Thereafter, as illustrated in FIG. 28B(6), the operator connects the liquid supply pipe 350 filled with the oil 203 in advance to the introduction port 107 at an angle θ′. Accordingly, the oil 203 enters the flow cell 2120 by the gravity applied to the oil 203, and the lower side of the array chip 100 is filled with the oil 203. The angle θ′ may be the same as or different from the angle θ.

### Conclusion of Eleventh Embodiment

In the present embodiment, since the flow cell 2120 has the liquid pool structure 2000, the solution 202 to be inspected extruded by the air 301 does not come out of the discharge port 106. Accordingly, it is possible to save time and effort required in the first to tenth embodiments to discard the solution to be inspected discharged from the discharge port 106. Accordingly, the liquid supply to the array chip 100 can be more easily performed. Since the solution 202 to be inspected does not come out from the discharge port 106, it is possible to reduce a risk that a component in the solution 202 to be inspected contaminates a component of another solution to be inspected in a laboratory.

### Modified Examples

The present disclosure is not limited to the above-described embodiments, and includes various modified examples. The aforementioned embodiments are described in detail in order to facilitate easy understanding of the present disclosure, and are not limited to necessarily include all the described components. A part of a certain embodiment can be replaced with a configuration of another embodiment. The configuration of another embodiment can be added to the configuration of a certain embodiment. A part of the configuration of another embodiment can be added to, deleted from, or replaced with a part of the configuration of each embodiment.

### EXAMPLES

Hereinafter, examples of the technology of the present disclosure will be described. The scope of the technology of the present disclosure is not limited to the contents described in the examples.

### Example 1

In Example 1, a target to be inspected was DNA, and the liquid supply method of the second embodiment was actually tested. A silicone tube (inner diameter of 1 mm) was prepared as the liquid supply pipe. As the solution to be inspected, a solution containing water, a primer for amplifying the DNA to be detected, a probe that specifically binds to the DNA to be detected and emits fluoresces, an enzyme required for the PCR reaction, dNTPs, and the like (QuantStudio (registered trademark) 3D Digital PCR Master Mix v2 manufactured by Thermo Fisher Scientific Inc.) was prepared. A QuantStudio (registered trademark) 3D Digital PCR Immersion fluid manufactured by Thermo Fisher Scientific Inc. was prepared as the oil.

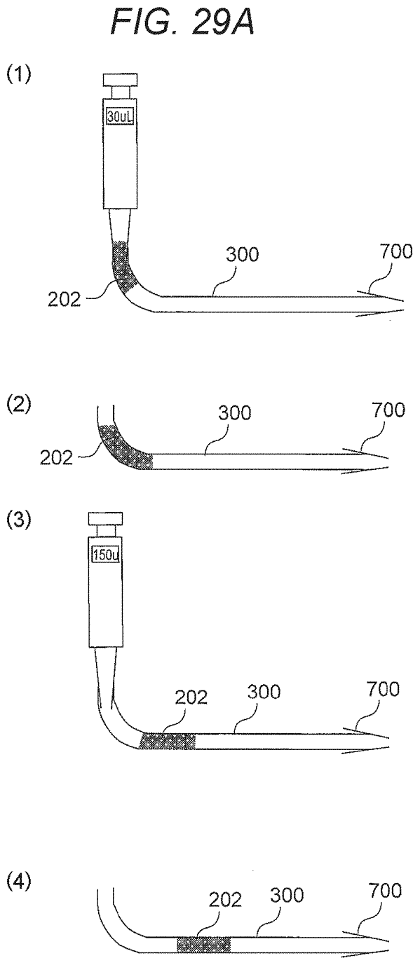

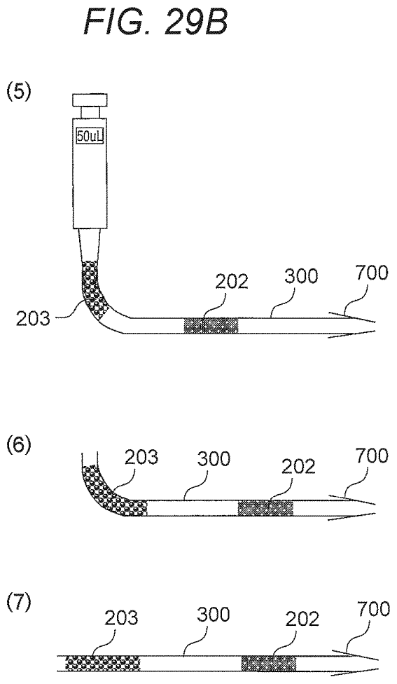

FIGS. 29A and 29B are diagrams illustrating a liquid supply method to the array chip 100 according to Example 1. First, the operator attached a nozzle 700 to a distal end of the liquid supply pipe 300. As illustrated in FIG. 29A(1), the solution 202 to be inspected was manually injected by using the pipette. The injection amount of the solution 202 to be inspected was set to about 30 μL. Thereafter, as illustrated in FIG. 29A(2), the pipette was removed from the liquid supply pipe 300. Subsequently, as illustrated in FIG. 29A(3), the distal end of the pipette was connected to the liquid supply pipe 300, and air was injected. The amount of air was about 150 μL to 300 μL. Thereafter, as illustrated in FIG. 29A(4), the pipette was removed from the liquid supply pipe 300. Thereafter, as illustrated in FIG. 29B(5), a distal end of the pipette was connected to the liquid supply pipe 300, and oil was injected. The amount of oil was about 50 μL. Thereafter, as illustrated in FIG. 29B(6), the pipette was removed from the liquid supply pipe 300. Subsequently, as illustrated in FIG. 29B(7), the liquid supply pipe was stretched. In the operation so far, a portion of the liquid supply pipe 300 other than the vicinity where the distal end portion of the pipette is inserted was installed on a substantially horizontal surface. Thus, the inserted solution to be inspected or oil did not leak out from a nozzle of the nozzle 700.

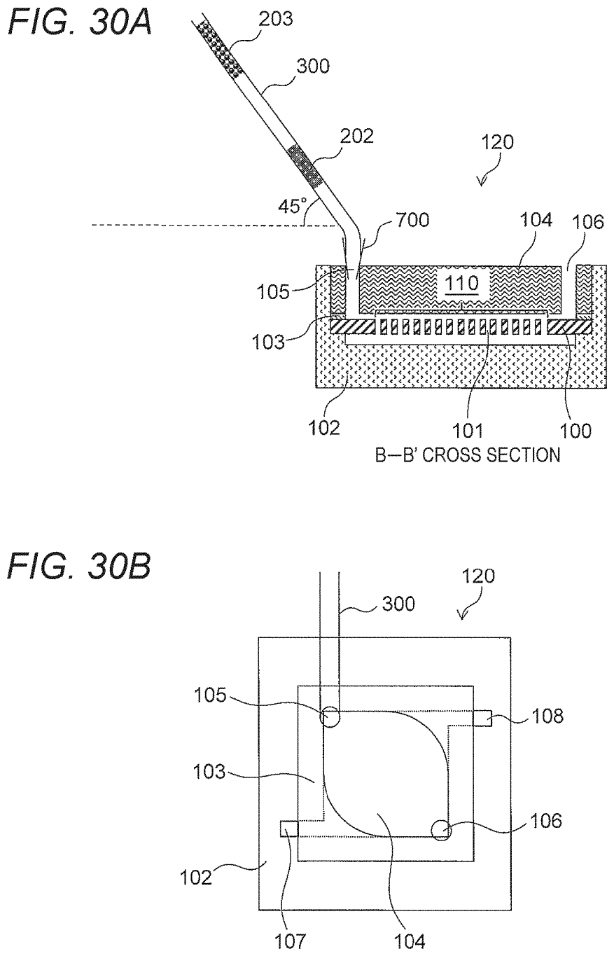

FIG. 30A is a cross-sectional view of the flow cell in a state where the liquid supply pipe 300 is connected. As illustrated in FIG. 30A, the nozzle 700 of the liquid supply pipe 300 was fitted into the introduction port 105 of the flow cell. The angle of the liquid supply pipe 300 was about 45 degrees. A thickness of the upper part 104 of the flow cell was about 1 mm. A thickness of the spacer 103 between the upper part of the flow cell and the array chip 100 was about 50 μm. The cross section of the introduction port 105 and the discharge port 106 of the flow cell parallel to the front surface of the array chip 100 was circular shape, and the diameter thereof was about 1 mm. The through-hole array 110 of the array chip 100 was present in a region of about 1 cm×1 cm. The cross section of the through-hole 101 parallel to the front surface of the array chip 100 was circular, and the diameter of the circle was about 60 μm. A shortest distance between the adjacent through-holes 101 was about 15 μm. A thickness of the array chip 100 was about 300 μm. A distance between the lower surface of the array chip 100 and the lower part 102 of the flow cell was about 300 μm.

FIG. 30B is a top view of the state of FIG. 30A. After setting to the state illustrated in FIG. 30A, the solution to be inspected, the air, and the oil were automatically supplied, and finally, the solution to be inspected was filled in the through-hole, and the front surface of the array chip 100 was filled with the oil.

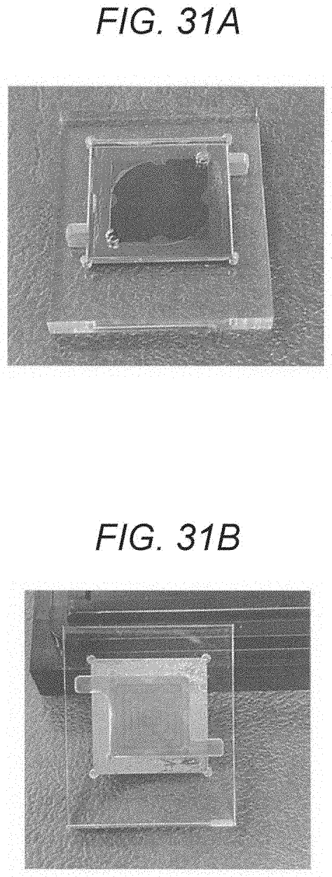

FIG. 31A is a photograph of the front surface of the flow cell after the liquid supply in Example 1 is performed. As illustrated in FIG. 31A, it can be seen that the liquid could be supplied to the flow cell without any problem.

FIG. 31B is a photograph of the back surface of the flow cell after the liquid supply in Example 1 is performed. From the photograph of FIG. 31B, there was no scene where the liquid leaks to the back surface of the array chip 100. In particular, when FIG. 31B is compared with the photograph (FIG. 6D) where the liquid leaked to the back surface of the array chip 100, it is obvious that the liquid did not leak to the back surface of the array chip 100 in Example 1. That is, in Example 1, due to the use of the method of the present disclosure, it could be demonstrated that the solution to be inspected can be confined in the through-holes and the front surface of the array chip 100 can be covered with the oil without leakage of the solution to be inspected to the back surface side of the array chip 100 through the through-holes or connection between the solutions in the adjacent through-holes. Thereafter, although not illustrated, the back surface side of the array chip 100 could also be covered with the oil by connecting the liquid supply pipe 350 to the introduction port 107 to the back surface side of the array chip 100 and pouring the oil from the liquid supply pipe. Thereafter, the PCR reaction is performed, and then excitation light is applied from the upper surface of the array chip 100 to perform fluorescence observation. In a case where the DNA sequence to be detected is present in the through-hole, fluorescence derived therefrom is observed.

What is claimed is:

1. A liquid supply method for supplying a solution to be inspected to a spot formed on a substrate, the method comprising:
preparing a liquid supply pipe in which the solution to be inspected, air, and oil are disposed in this order; and
installing the liquid supply pipe above the substrate at an angle such that the solution to be inspected is positioned on a lowermost side and the solution to be inspected, the air, and the oil flow onto a front surface of the substrate by gravity,
wherein
a cross-sectional area of the liquid supply pipe is designed such that the air continues to be present between the solution to be inspected and the oil while the solution to be inspected, the air, and the oil are flowing through the liquid supply pipe, and
after the solution to be inspected is supplied to the spot, the solution to be inspected present on the front surface of the substrate is replaced with the air, and then the liquid supply progresses such that the oil covers the front surface of the substrate.

2. The liquid supply method according to claim 1, wherein the spot is a through-hole.

3. The liquid supply method according to claim 2, wherein the amount of the solution to be inspected and the amount of the oil are adjusted such that a pressure applied to the solution to be inspected on the substrate is smaller than a bursting pressure at which a liquid level of the solution to be inspected formed on an outlet side of the through-hole is not able to maintain a shape while the solution to be inspected is being supplied to the through-hole.

4. The liquid supply method according to claim 1, wherein the substrate has a hydrophilic portion and a hydrophobic portion, and the spot is the hydrophilic portion.

5. The liquid supply method according to claim 1, wherein the spot is a well.

6. The liquid supply method according to claim 1, wherein at least one of a case where an inner diameter of the liquid supply pipe is smaller than 2.5 mm and a case where a cross-sectional area of a hollow portion of the liquid supply pipe is smaller than 2.5×2.5×π/4 mm² is satisfied.

7. The liquid supply method according to claim 1, wherein at least one of a case where an inner diameter of the liquid supply pipe is equal to or smaller than 1.5 mm and a case where a cross-sectional area of a hollow portion of the liquid supply pipe is equal to or smaller than 1.5×1.5×π/4 mm² is satisfied.

8. The liquid supply method according to claim 1, wherein
the preparing of the liquid supply pipe includes filling the liquid supply pipe with the solution to be inspected, the air, and the oil at a first angle at which the solution to be inspected continues to be held in the liquid supply pipe, and
the installing of the liquid supply pipe above the substrate includes changing an angle of the liquid supply pipe to a second angle larger than the first angle after the filling is completed.

9. The liquid supply method according to claim 8, wherein the first angle is an angle at which the solution to be inspected is stopped in the liquid supply pipe in a stage in which the liquid supply pipe is filled with only the solution to be inspected.

10. The liquid supply method according to claim 1, further comprising increasing an angle of the liquid supply pipe with respect to the substrate with a lapse of time after the liquid supply pipe is installed above the substrate.

11. The liquid supply method according to claim 2, further comprising supplying the oil to a lower surface of the substrate after the front surface of the substrate is covered with the oil.

12. The liquid supply method according to claim 1, wherein
the substrate is installed in a flow cell that defines a flow path on the front surface of the substrate, and
the flow path is communicatively connected to at least two air holes.

13. The liquid supply method according to claim 1, wherein the solution to be inspected contains a substance indicating fluorescence when there is a substance to be detected.

14. The liquid supply method according to claim 13, further comprising performing fluorescence observation of the substrate after the liquid supply is completed.

15. The liquid supply method according to claim 1, wherein the oil includes at least one of mineral oil, paraffin, silicone oil, Fluorinert, and fluorine-containing oil.

16. The liquid supply method according to claim 1, wherein the liquid supply pipe is made of a plastic material.

17. The liquid supply method according to claim 1, wherein a material of the liquid supply pipe includes at least one of fluorocarbon resin, silicone, PDMS, acrylic, rubber, elastomer, polyester, olefin, polyamide, urethane, polyurethane, polypropylene, vinyl chloride, and polycarbonate.
